(19) United States
(12) Patent Application Publication
(10) Pub. No.: US 2025/0328201 A1
(43) Pub. Date: Oct. 23, 2025

(54) Sheet for Pen Input Device

(71) Applicants: Wacom Co., Ltd., Saitama (JP); Bando Chemical Industries, Ltd., Hyogo (JP)

(72) Inventors: So KATO, Saitama (JP); Yutaka KAMADA, Hyogo (JP)

(21) Appl. No.: 19/210,444

(22) Filed: May 16, 2025

Related U.S. Application Data
(63) Continuation of application No. PCT/JP2023/040925, filed on Nov. 14, 2023.

(30) Foreign Application Priority Data
Nov. 28, 2022 (JP) 2022-189147

(51) Int. Cl. G06F 3/039; G01L 1/14

(52) U.S. Cl. CPC G06F 3/0393; G01L 1/142

(57) ABSTRACT

A pen input device sheet is disposed over a position detection region of a position detecting sensor. The pen input device sheet includes an elastic material layer that has elasticity and has a side opposite to a side of the position detecting sensor employed as a side of a writing input surface to which writing input with an electronic pen is to be made. The elastic material layer has a first uneven pattern formed along a direction orthogonal to a thickness direction of the elastic material layer and a second uneven pattern that is formed along a direction orthogonal to the thickness direction of the elastic material layer and is different from the first uneven pattern.

### BACKGROUND OF THE INVENTION

### 1. Field of the Invention

This invention relates to a pen input device sheet that is used for a pen input device and gets contact with the pen tip of an electronic pen.

### 2. Description of the Related Art

Recently, pen input devices have come to be used as input devices for pieces of small-size electronic equipment such as a highly-functional mobile phone terminal called a smartphone and a pad-type terminal. The pen input device includes an electronic pen and a position detecting device that detects an indicated position indicated by this electronic pen. Reduction in the thickness of the electronic pen used for such a pen input device for small-size electronic equipment has been advanced, and the electronic pen having a pen tip with a diameter similar to that of the pen tip of a commercially-available ballpoint pen has also been increasing.

Due to also such a background, the electronic pen has been required to allow input with a writing feel like, for example, a writing feel obtained when writing on paper is executed with a pencil or a ballpoint pen. However, an input surface (surface with which the pen tip of the electronic pen is brought into contact and to which writing input is made) of the input device of the above-described electronic equipment is hard. In particular, when the electronic equipment includes a display screen, a hard surface such as a glass surface is employed as the input surface. Hence, it is difficult to obtain a writing feel like one obtained when writing on paper is executed with a pencil or a ballpoint pen, as the writing feel obtained on the input surface with the electronic pen.

Thus, for the purpose of improving the writing feel obtained on the input surface with the electronic pen, as related arts, attaching a sheet (pen input device sheet), for which contrivance is made to develop a writing feel like the above-described one, onto an input surface of a pen input device has been executed.

For example, pen input device sheets (films) in which an uneven shape of a sheet surface is controlled to adjust a writing feel have been proposed in Japanese Patent Laid-open No. 2014-137640 (Patent Document 1) and Japanese Patent Laid-open No. 2014-149817 (Patent Document 2). Further, a pen input device sheet (film) in which coating with a soft resin is executed for a sheet surface to develop a writing feel has been proposed in Japanese Patent Laid-open No. 2006-119772 (Patent Document 3).

Incidentally, there is a demand to select a target combination of a writing material and a writing medium sought as a writing feel in writing input with an electronic pen and obtain a writing feel equivalent or close to a writing feel obtained with the target combination of the writing material and the writing medium. For example, there is a demand to obtain, when writing input with an electronic pen is made, a writing feel equivalent or close to one obtained when writing input is made on paper such as copy paper with a pencil.

However, in the method in which the writing feel is adjusted by control of the uneven shape of a surface of the pen input device sheet as described in Patent Document 1 and Patent Document 2, and the method in which coating with a soft resin is executed for a surface as described in Patent Document 3, there is a problem that it is impossible to reproduce a feeling (writing feel or sense of writing pressure) made by hollowing of paper when writing is executed on the paper with a pen. In addition, these Patent Document 1 and Patent Document 2 do not have an idea of obtaining a writing feel equivalent or close to a writing feel obtained when writing input is made to a predetermined writing medium with a predetermined writing material, and thus involve a problem that it is impossible to solve the above-described problem.

### SUMMARY OF THE INVENTION

In view of the above point, this invention intends to provide a pen input device sheet configured to be capable of achieving, when writing input is made with an electronic pen, a writing feel equivalent or close to, for example, a writing feel obtained when writing on paper is executed with a pencil, with a comparatively simple configuration.

In order to solve the above-described problems, there is provided a pen input device sheet to be disposed over a position detection region of a position detecting sensor, the pen input device sheet including an elastic material layer that has elasticity and has a side opposite to a side of the position detecting sensor employed as a side of a writing input surface to which writing input with an electronic pen is to be made. The elastic material layer has a first uneven pattern formed along a direction orthogonal to a thickness direction of the elastic material layer and a second uneven pattern that is formed along a direction orthogonal to the thickness direction of the elastic material layer and is different from the first uneven pattern.

According to the pen input device sheet with the above-described configuration, it is possible to obtain a pen input device sheet that exhibits a writing feel equivalent or close to a writing feel obtained with a combination of a writing material and a writing medium desired by a user, when writing input is made with an electronic pen.

### BRIEF DESCRIPTION OF THE DRAWINGS

FIG. 1 is a diagram for explaining one example of a pen input device for which a pen input device sheet according to this invention is used;

FIG. 2 is a diagram for explaining one example of an electronic pen with which writing input is made on the pen input device sheet according to this invention;

FIG. 3 is a diagram for explaining a circuit configuration example of a position detecting device of the pen input device for which the pen input device sheet according to this invention is used;

FIGS. 4A to 4C are diagrams depicting examples of vibration frequency characteristics of a kinetic friction coefficient in one example of a writing material and a writing medium employed as a target for an embodiment of the pen input device sheet according to this invention;

FIGS. 5A to 5C are diagrams depicting examples of the vibration frequency characteristics of the kinetic friction coefficient in one example of the writing material and the writing medium employed as the target for the embodiment of the pen input device sheet according to this invention;

FIGS. 6A to 6C are diagrams depicting examples of the vibration frequency characteristics of the kinetic friction coefficient in one example of the writing material and the writing medium employed as the target for the embodiment of the pen input device sheet according to this invention;

FIGS. 7A to 7C are diagrams depicting examples of the vibration frequency characteristics of the kinetic friction coefficient in one example of the writing material and the writing medium employed as the target for the embodiment of the pen input device sheet according to this invention;

FIG. 8 is a sectional view for explaining a configuration example of a first embodiment of the pen input device sheet according to this invention;

FIG. 9 is a diagram for explaining a major part of the configuration example of the first embodiment of the pen input device sheet according to this invention;

FIG. 10 is a diagram depicting one example of measurement conditions in measurement of surface roughness in the first embodiment of the pen input device sheet according to this invention;

FIG. 11 is a diagram depicting one example of evaluation conditions in evaluation of a measurement result of the surface roughness in the first embodiment of the pen input device sheet according to this invention;

FIGS. 12A and 12B are diagrams depicting table examples of the measurement result of the surface roughness in the first embodiment of the pen input device sheet according to this invention;

FIG. 13 is a diagram depicting a table example of various values obtained from the measurement result of the surface roughness in the first embodiment of the pen input device sheet according to this invention;

FIG. 14 is a sectional view for explaining a first modification of the configuration example of the first embodiment of the pen input device sheet according to this invention;

FIG. 15 is a diagram for explaining a second modification of the configuration example of the first embodiment of the pen input device sheet according to this invention;

FIG. 16 is a diagram for explaining a third modification of the configuration example of the first embodiment of the pen input device sheet according to this invention;

FIG. 17 is a sectional view for explaining a configuration example of a second embodiment of the pen input device sheet according to this invention;

FIG. 18 is a diagram for explaining a major part of the configuration example of the second embodiment of the pen input device sheet according to this invention;

FIG. 19 is a sectional view for explaining a configuration example of a third embodiment of the pen input device sheet according to this invention; and

FIG. 20 is a sectional view for explaining a configuration example of a fourth embodiment of the pen input device sheet according to this invention.

### DETAILED DESCRIPTION OF THE PREFERRED EMBODIMENTS

### Configuration Example of Pen Input Device

A description is given of a configuration example of one example of a pen input device to which a pen input device sheet according to this invention is applied.

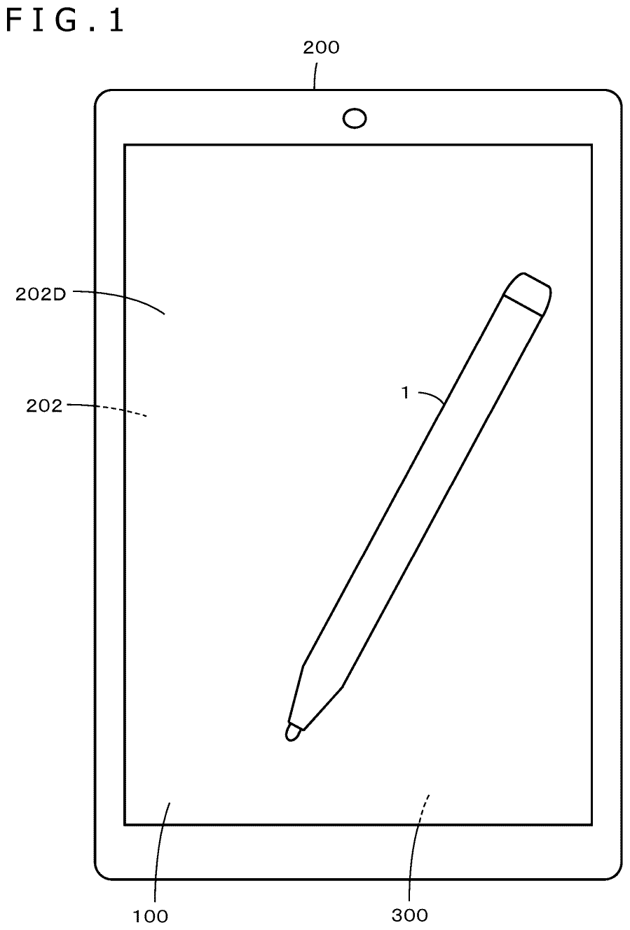

FIG. 1 depicts one example of a tablet-type information terminal 200 as one example of the pen input device. In this example, the tablet-type information terminal 200 includes a display device 202, a liquid crystal display (LCD) in this example, in a terminal casing, and includes a position detecting device 300 of an electromagnetic induction system under (on a back surface side of) a display screen 202D of the display device 202. When the tablet-type information terminal 200 does not include the display device 202, the tablet-type information terminal 200 is a pen tablet-type terminal and includes the position detecting device 300 under a top plate (upper surface plate forming an input surface of the pen tablet-type terminal) of the terminal casing.

In the case of the example of FIG. 1, although depiction is omitted in FIG. 1, the position detecting device 300 includes a position detecting sensor of an electromagnetic induction system having a position detection region with a size corresponding to a display region of the display screen 202D of the display device 202. This position detecting sensor is disposed in a state in which the display region of the display screen 202D and the position detection region overlap each other. Therefore, the tablet-type information terminal 200 of this example is configured such that almost the whole of the display region of the display screen 202D is the position detection region of the position detecting sensor.

The position detecting sensor may be disposed such that the position detection region corresponds to not almost the whole of the display region of the display screen 202D but a partial region in the display region.

Further, the tablet-type information terminal 200 of this example has an electronic pen 1 that executes position indication for the position detecting sensor of the position detecting device 300 by an electromagnetic induction system. Moreover, a pen input device sheet 100 of a first embodiment of this invention is disposed to be attached onto the display screen 202D of the tablet-type information terminal 200. In this example, almost the whole of the display region of the display screen 202D is employed as the position detection region of the position detecting sensor. Thus, the pen input device sheet 100 is disposed to cover the whole of the display region of the display screen 202D. Further, the exposed surface of the pen input device sheet 100 serves as an input surface of position indication by the electronic pen 1, that is, a writing input surface.

It is obvious that the pen input device sheet 100 of the embodiment of this invention may be used also in the pen tablet-type terminal that does not include the display device 202.

A user brings a tip portion (pen tip) of a core body of the electronic pen 1 into contact with the pen input device sheet 100, and executes input operation of, for example, drawing a line on the pen input device sheet 100 in a state in which a predetermined writing pressure is applied to the pen tip. The position detecting device 300 detects the drawing input on the pen input device sheet 100 by the electronic pen 1 and detects the writing pressure of the electronic pen 1 in this drawing input.

### Description of Mechanical Configuration Example of Electronic Pen 1

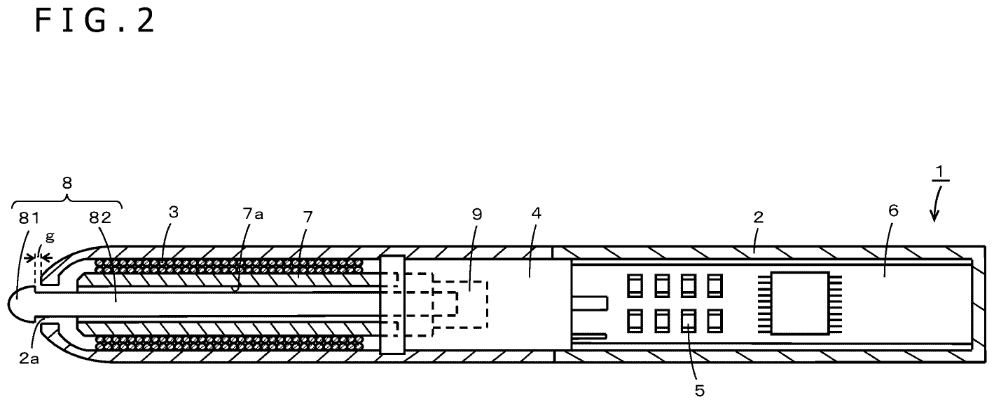

FIG. 2 depicts an outline of the electronic pen 1 used with the tablet-type information terminal 200 of this example. The electronic pen 1 of this example is an electronic pen of an electromagnetic induction system. In a hollow portion of a casing 2 with a cylindrical shape, a coil 3 for position detection, a writing pressure detecting portion 4, and a printed board 6 on which such electronic parts as a capacitor 5 forming a resonant circuit with the coil 3 are mounted are sequentially arranged in an axial center direction and are housed.

The coil 3 is wound around a ferrite core 7 as an example of a magnetic core having a through-hole 7a extending in the axial center direction, and is housed near an opening 2a on the pen tip side in the casing 2. The writing pressure detecting portion 4 includes a fitting portion 9 into which an axial center portion 82 of a core body 8 is fitted.

In this example, the core body 8 has a configuration in which a tip portion 81 serving as the pen tip and the axial center portion 82 are monolithically coupled. The core body 8 is inserted into the casing 2 from the side of the axial center portion 82 through the opening 2a and is made to penetrate through the through-hole 7a of the ferrite core 7. Further, an end portion of the axial center portion 82 of the core body 8 is fitted into and held by the fitting portion 9 made in the writing pressure detecting portion 4. When the end portion of the axial center portion 82 is fitted into the fitting portion 9, the tip portion 81 of the core body 8 is set to such a state as to protrude to the external from the opening 2a of the casing 2 as depicted in FIG. 2.

In the example of FIG. 2, the writing pressure detecting portion 4 has a configuration of a variable-capacitance capacitor that detects the writing pressure applied to the tip portion 81 of the core body 8 as change in capacitance, and forms the resonant circuit with the coil 3 and the capacitor 5 through electrical connection in the printed board 6.

The electronic pen 1 of the electromagnetic induction system in this example executes interaction of a signal with the position detecting sensor of the position detecting device 300 by the resonant circuit. On the basis of this, the position detecting device 300 detects coordinates of a position indicated by the electronic pen 1.

The writing pressure detecting portion 4 receives the pressure applied to the core body 8 in the axial center direction, through the fitting portion 9, and detects the pressure in the axial center direction as change in the capacitance. Moreover, in the electronic pen 1 in this example, a resonant frequency of the resonant circuit changes due to this change in the capacitance. The position detecting device detects the writing pressure applied to the tip portion 81 of the core body 8 of the electronic pen 1 on the basis of detection of this change in the resonant frequency.

### Circuit Configuration for Position Detection and Writing Pressure Detection in Position Detecting Device Used with Electronic Pen 1

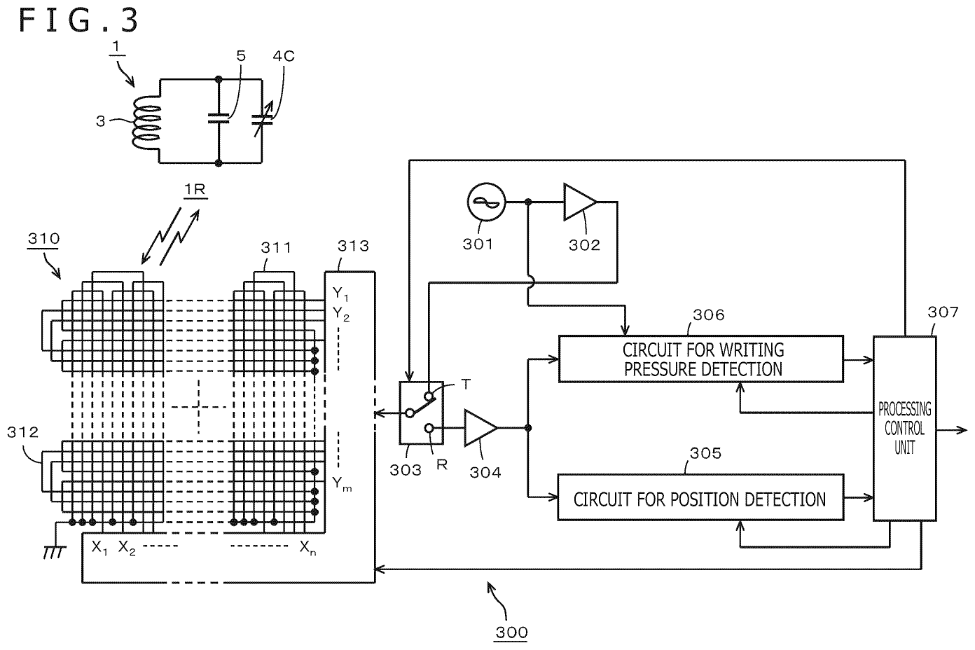

Next, with reference to FIG. 3, a description is given of a circuit configuration example of the position detecting device 300 that executes detection of a position indicated by the above-described electronic pen 1 and detection of the writing pressure (=load) applied to the electronic pen 1, and operation thereof.

As depicted in FIG. 3, in the electronic pen 1, one end portion and the other end portion of the coil 3 are connected to the capacitor 5, and a variable-capacitance capacitor 4C formed by the writing pressure detecting portion 4 is connected in parallel to the coil 3 and the capacitor 5, so that a resonant circuit 1R is formed.

The position detecting device 300 of the electromagnetic induction system in this embodiment transmits a signal to the electronic pen 1 by electromagnetic induction coupling. The electronic pen 1 returns the signal received from the position detecting device 300, through the resonant circuit 1R.

The position detecting device 300 receives the returned signal from the resonant circuit 1R of the electronic pen 1 by electromagnetic induction coupling, and detects a position on the sensor indicated by the electronic pen 1 from a position on the sensor at which the received signal is detected. In addition, the position detecting device 300 detects change in the resonant frequency by detecting phase change of the signal received from the resonant circuit 1R of the electronic pen 1 by electromagnetic induction coupling, and detects the writing pressure applied to the tip portion 81 of the core body 8 of the electronic pen 1.

In the position detecting device 300, an X-axis direction loop coil group 311 and a Y-axis direction loop coil group 312 are stacked to form a position detecting sensor 310 composed of position detecting coils. Further, in the position detecting device 300, a selection circuit 313 to which the X-axis direction loop coil group 311 and the Y-axis direction loop coil group 312 are connected is disposed. The selection circuit 313 sequentially selects one loop coil in the two loop coil groups 311 and 312.

Moreover, disposed in the position detecting device 300 are an oscillator 301, a current driver 302, a switching connection circuit 303, a reception amplifier 304, a circuit 305 for position detection, a circuit 306 for writing pressure detection, and a processing control unit 307. The processing control unit 307 is configured by a microcomputer. The processing control unit 307 controls selection of the loop coil in the selection circuit 313 and switching of the switching connection circuit 303, and controls processing timings in the circuit 305 for position detection and the circuit 306 for writing pressure detection.

The oscillator 301 generates an alternating-current signal with a frequency f0. Further, the oscillator 301 supplies the generated alternating-current signal to the current driver 302 and the circuit 306 for writing pressure detection. The current driver 302 converts the alternating-current signal supplied from the oscillator 301 to a current and sends out the current to the switching connection circuit 303. The switching connection circuit 303 switches the connection target (transmission-side terminal T or reception-side terminal R) to which the loop coil selected by the selection circuit 313 is connected, by control from the processing control unit 307. As for these connection targets, the transmission-side terminal T is connected to the current driver 302, and the reception-side terminal R is connected to the reception amplifier 304.

An induced voltage generated in the loop coil selected by the selection circuit 313 is sent to the reception amplifier 304 through the selection circuit 313 and the switching connection circuit 303. The reception amplifier 304 amplifies the induced voltage supplied from the loop coil and sends out the amplified voltage to the circuit 305 for position detection and the circuit 306 for writing pressure detection.

An induced voltage is generated in each loop coil of the X-axis direction loop coil group 311 and the Y-axis direction loop coil group 312 by radio waves transmitted from the electronic pen 1. The circuit 305 for position detection executes detection of the induced voltage generated in the loop coil, that is, a received signal, converts a detection output signal thereof to a digital signal, and outputs it to the processing control unit 307. The processing control unit 307 calculates coordinate values of the position in the X-axis direction and the Y-axis direction indicated by the electronic pen 1, on the basis of the digital signal from the circuit 305 for position detection, that is, the level of the voltage value of the induced voltage generated in each loop coil.

Meanwhile, the circuit 306 for writing pressure detection executes synchronous detection of an output signal of the reception amplifier 304 with the alternating-current signal from the oscillator 301, obtains a signal at a level according to a phase difference (frequency deviation) between them, converts the signal according to the phase difference (frequency deviation) to a digital signal, and outputs it to the processing control unit 307. The processing control unit 307 detects the pressure applied to the electronic pen 1 on the basis of the digital signal from the circuit 306 for writing pressure detection, that is, the level of the signal according to the phase difference (frequency deviation) between the transmitted radio wave and the received radio wave.

### Description of Outline of Procedure for Creating Pen Input Device Sheets of Embodiments

In pen input device sheets of several embodiments to be described below, including the pen input device sheet 100 of the first embodiment, a configuration is made to allow not only enhancement of a writing feel obtained when writing input is made to paper as an example of a writing medium with a writing material such as a pencil, but also selection of a target writing material and a target writing medium a writing feel with which is desired to be obtained with an electronic pen and obtainment of a writing feel as close as possible to a writing feel obtained when writing input is made on the selected writing medium with the selected writing material.

Prior to description of configuration examples of the pen input device sheets of the embodiments, an outline of a procedure for creating the pen input device sheets of the embodiments is described.

(1) First, a creator of the pen input device sheet of one of the embodiments selects a target combination of a writing material and a writing medium a writing feel with which is desired to be obtained with an electronic pen.

(2) Next, the selected writing material is caused to make, for example, a linear movement on the selected writing medium in a predetermined direction at a predetermined speed in a state in which a predetermined writing pressure is applied, and a kinetic friction coefficient on that occasion is measured. At this time, the kinetic friction coefficient is measured as time-series change (vibration change) with elapse of time in the linear movement being plotted on a horizontal axis.

(3) Next, a Fourier transform of the time-series change in the kinetic friction coefficient obtained as the measurement result is performed to obtain a power spectrum of change (vibration) in the kinetic friction coefficient over time, that is, a vibration frequency characteristic of the kinetic friction coefficient. Then, in the embodiment, a frequency distribution of magnitude of the vibration of the kinetic friction coefficient in the obtained vibration frequency characteristic of the kinetic friction coefficient and a frequency at which the magnitude of the vibration is prominent from adjacent frequency ranges are detected, and the frequency that exhibits a peak of the magnitude of the vibration prominent from a broad waveform of the frequency distribution of the magnitude of the vibration is thus detected. The frequency at which the magnitude of the vibration is prominent does not appear, depending on the combination of the writing material and the writing medium, in some cases. In such a combination, the maximum value that is the apex of a mountain part included in the frequency distribution of the magnitude of the vibration is the peak of the magnitude of the vibration.

(4) Next, the pen input device sheet of the embodiment of this invention is created by making such a configuration that, in the case of the selected combination of the writing material and the writing medium obtained in the above manner, the pen input device sheet has the vibration frequency characteristic of the kinetic friction coefficient that matches the vibration frequency characteristic of the kinetic friction coefficient obtained when the selected writing material is moved on the selected writing medium at the predetermined speed.

That is, the pen input device sheet of the embodiment of this invention is configured such that the vibration frequency characteristic of the kinetic friction coefficient obtained when the electronic pen is moved on the writing input surface of the created pen input device sheet of the embodiment of this invention at a speed same as that adopted when the measurement of the kinetic friction coefficient has been executed with the selected combination of the writing material and the writing medium matches the vibration frequency characteristic of the kinetic friction coefficient obtained with the selected combination of the writing material and the writing medium.

In this case, as the method for causing the two vibration frequency characteristics of the kinetic friction coefficient to match each other, in the embodiment, in particular, the frequency that exhibits a peak of the magnitude of the vibration of the kinetic friction coefficient in the vibration frequency characteristic of the kinetic friction coefficient obtained regarding the pen input device sheet is made to fall within a range of ±ΔHz from a frequency fp at which a peak of the magnitude of the vibration of the kinetic friction coefficient exists in the vibration frequency characteristic of the kinetic friction coefficient obtained with the selected combination of the writing material and the writing medium.

Here, in the embodiment, the value of Δ in the frequency fp±ΔHz is set according to the width of the writing pressure applied to the pen tip of the electronic pen 1 by the user in writing. Further, in view of the fact that there may be various kinds of hardness as the tip portion of the writing material that gets contact with the writing medium, that is, in the embodiment, the fact that there may be several kinds of hardness as the core of a pencil, the value of Δ is set in consideration of the difference in the frequency that exhibits the peak depending on the difference in these several kinds of hardness. The difference in the hardness of the pen tip exists not only in a pencil but also in, for example, a fountain pen. In addition, a difference also exists in the size of the ball at the tip (thinness of the pen tip) of a ballpoint pen. The value of Δ is set according to these differences.

It has successfully been confirmed as sensory evaluation that, when writing input with the electronic pen is made on the pen input device sheet of the embodiment of this invention created in this manner, a writing feel equivalent or close to the writing feel obtained with the selected combination of the writing material and the writing medium is obtained.

As above, in the pen input device sheet of the embodiment of this invention, attention is paid to the vibration frequency characteristic of the kinetic friction coefficient obtained with a combination of a writing material and a writing medium, and the pen input device sheet is configured such that the vibration frequency characteristic of the kinetic friction coefficient of the pen input device sheet of the embodiment matches the vibration frequency characteristic of the kinetic friction coefficient obtained with the selected target combination of the writing material and the writing medium. This can obtain a writing feel equivalent or close to the writing feel obtained with the selected combination of the writing material and the writing medium.

Further, in the pen input device sheet of the embodiment of this invention, the pen input device sheet is configured such that the frequency having the peak of the magnitude of the vibration of the kinetic friction coefficient in the vibration frequency characteristic of the kinetic friction coefficient of the pen input device sheet falls within the frequency range in which the peak of the magnitude of the vibration of the kinetic friction coefficient in the vibration frequency characteristic of the kinetic friction coefficient obtained under various writing pressures exists with the selected combination of the writing material and the writing medium. Hence, a writing feel equivalent or close to the writing feel obtained with the selected combination of the writing material and the writing medium can be obtained even when the writing pressure applied to the electronic pen in writing changes.

Moreover, in the pen input device sheet of the embodiment of this invention, the pen input device sheet is configured such that the frequency having the peak of the magnitude of the vibration of the kinetic friction coefficient in the vibration frequency characteristic of the kinetic friction coefficient of the pen input device sheet falls within the frequency range in which the peak of the magnitude of the vibration of the kinetic friction coefficient in the vibration frequency characteristic of the kinetic friction coefficient obtained depending on the difference in the hardness of the tip portion of the selected writing material that gets contact with the writing medium exists with the selected combination of the writing material and the writing medium. Hence, a writing feel equivalent or close to the writing feel obtained with the selected combination of the writing material and the writing medium can be obtained irrespective of the difference in the hardness of the core body of the electronic pen.

### Description of Pen Input Device Sheet 100 of First Embodiment

The pen input device sheet 100 of the first embodiment corresponds to a case in which a target combination of a writing material and a writing medium a writing feel with which is desired to be obtained with the electronic pen is a combination of a pencil and paper.

<Vibration Frequency Characteristic of Kinetic Friction Coefficient with Target Combination of Writing Material and Writing Medium>

In this example, Hi-uni pencils made by MITSUBISHI PENCIL COMPANY, LIMITED were used as the pencil as an example of the writing material, and copy paper was used as an example of the writing medium.

Pencils having the core hardness of 4B, 2B, HB, and 2H were each moved on one piece of copy paper, and the kinetic friction coefficient on that occasion was measured. In this case, in a state in which one of three kinds of pressures, 50 gf, 100 gf, and 200 gf, was applied to the pencil as the writing pressure, each pencil was caused to make, for example, a linear movement on the copy paper at a speed of 10 mm/second, and the measurement was executed. The pencil was moved in a state in which the pencil was inclined at an angle of approximately 45 to 60 degrees with respect to the plane of the copy paper. Next, a Fourier transform of the time-series change in the kinetic friction coefficient obtained as the measurement result was performed to obtain the power spectrum of change (vibration) in the kinetic friction coefficient over time, that is, the vibration frequency characteristic of the kinetic friction coefficient.

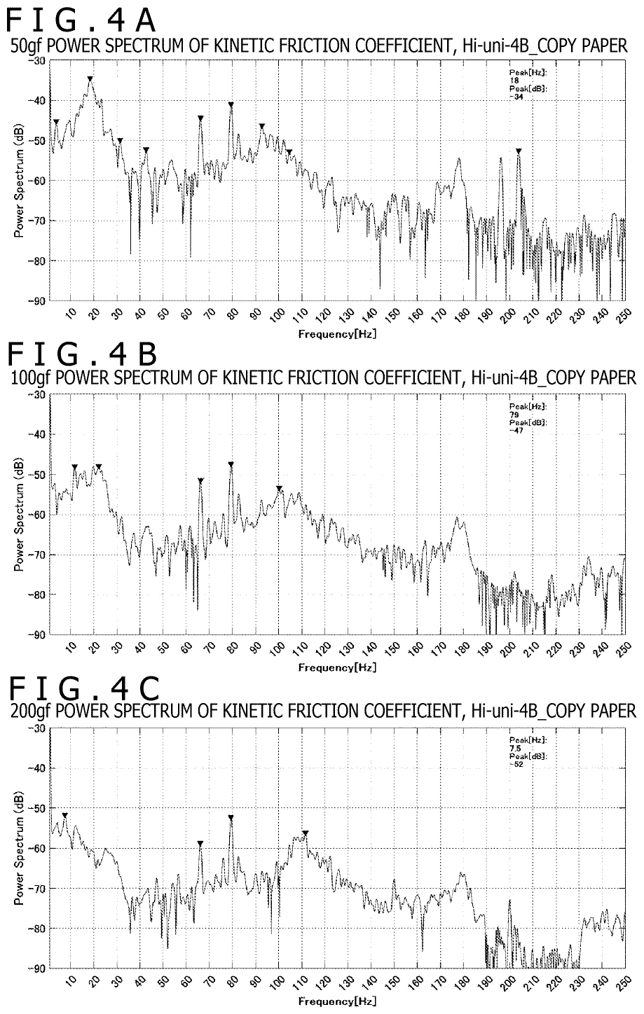

The obtained vibration frequency characteristics of the kinetic friction coefficient are depicted in FIGS. 4A to 7C. FIGS. 4A to 4C, FIGS. 5A to 5C, FIGS. 6A to 6C, and FIGS. 7A to 7C depict the vibration frequency characteristics of the kinetic friction coefficient in cases in which pencils having the core hardness of 4B, 2B, HB, and 2H, respectively, were used for writing.

Moreover, FIGS. 4A, 5A, 6A, and 7A, FIGS. 4B, 5B, 6B, and 7B, and FIGS. 4C, 5C, 6C, and 7C depict the vibration frequency characteristics of the kinetic friction coefficient in cases in which 50 gf, 100 gf, and 200 gf, respectively, were applied to the pencils as the writing pressure.

With reference to FIGS. 4A, 5A, 6A, and 7A, it can be confirmed that the vibration frequency characteristics of the kinetic friction coefficient in the cases in which writing is executed on the copy paper with the pencil to which 50 gf is applied as the writing pressure are characteristics in which the peak of the magnitude of the vibration of the kinetic friction coefficient is exhibited at frequencies of 18 Hz, 20 Hz, 17 Hz, and 15 Hz with the pencils having the core hardness of 4B, 2B, HB, and 2H, respectively. In general, the writing pressure applied when a user holds a pencil and executes writing on a writing medium is approximately 50 gf.

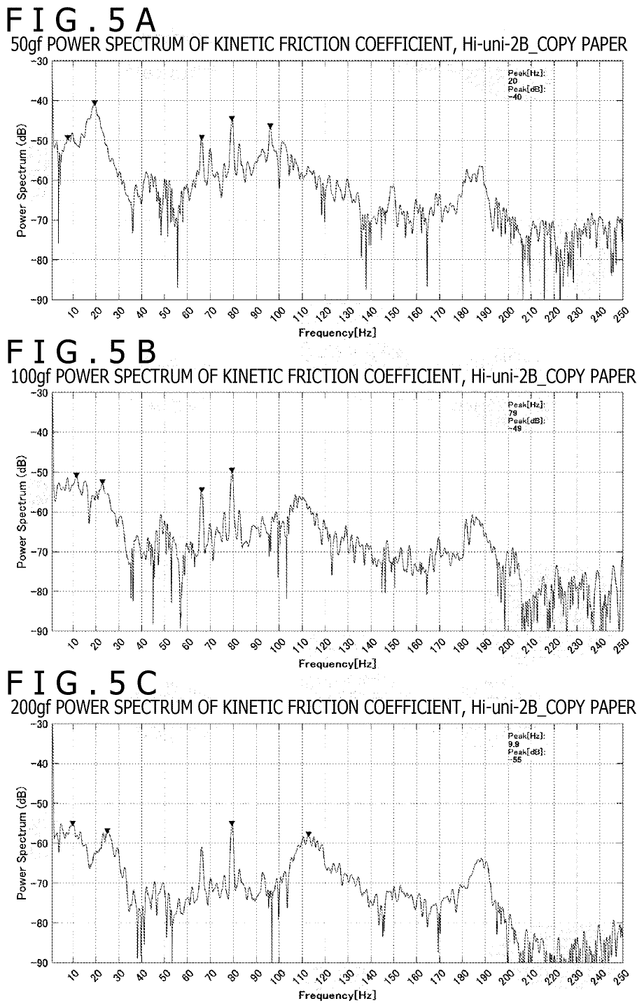

With reference to FIGS. 4B and 5B, a frequency at which the magnitude of the vibration is prominent from adjacent frequency ranges exists at 60 Hz or higher. However, as a broad waveform over several tens of hertz in the frequency distribution of the magnitude of the vibration, a tendency of distribution of the power spectrum having the maximum value at a frequency of 35 Hz or lower is indicated. In particular, in writing by a soft core of a pencil, the core tip readily wears off in the process of the writing. At this time, the friction vibration of the writing is affected by vibration attributable to crushing of the core caused when the core wears off, and the frequency of the measured friction vibration is dispersed. From this, it can be confirmed that characteristics in which, as the peak of the magnitude of the vibration in the cases in which writing is executed on the copy paper with the pencil to which 100 gf is applied as the writing pressure, the peak of the magnitude of the vibration of the kinetic friction coefficient is exhibited at frequencies of 22 Hz and 12 Hz with the pencils having the core hardness of 4B and 2B, respectively, are obtained.

Further, with reference to FIGS. 4C and 5C, it can be confirmed that the vibration frequency characteristics of the kinetic friction coefficient in the cases in which writing is executed on the copy paper with the pencil to which 200 gf is applied as the writing pressure are characteristics in which the peak of the magnitude of the vibration of the kinetic friction coefficient is exhibited at frequencies of 8 Hz and 10 Hz with the pencils having the core hardness of 4B and 2B, respectively.

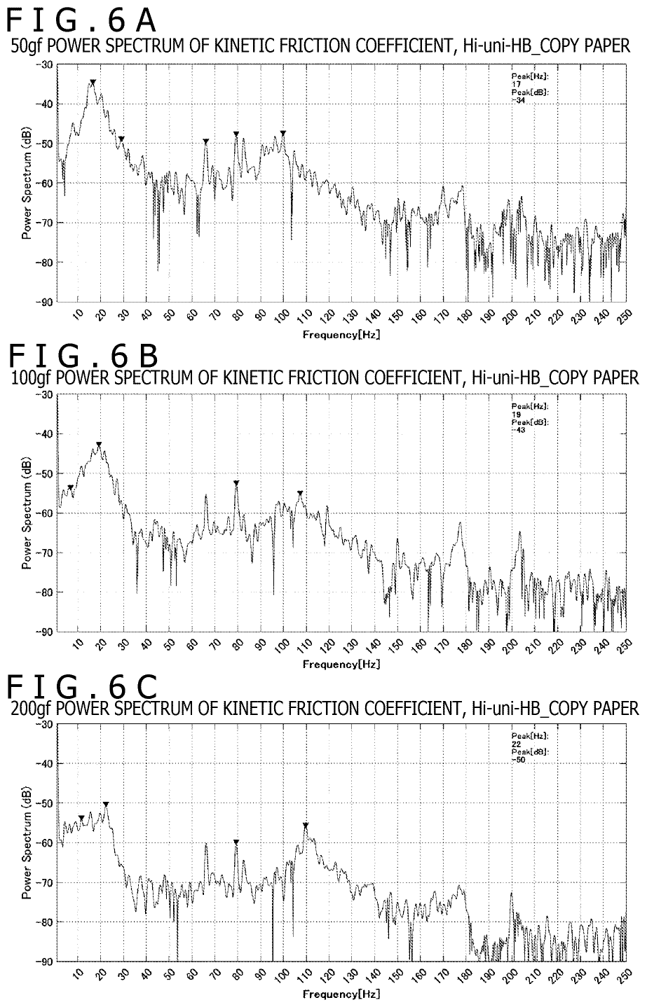

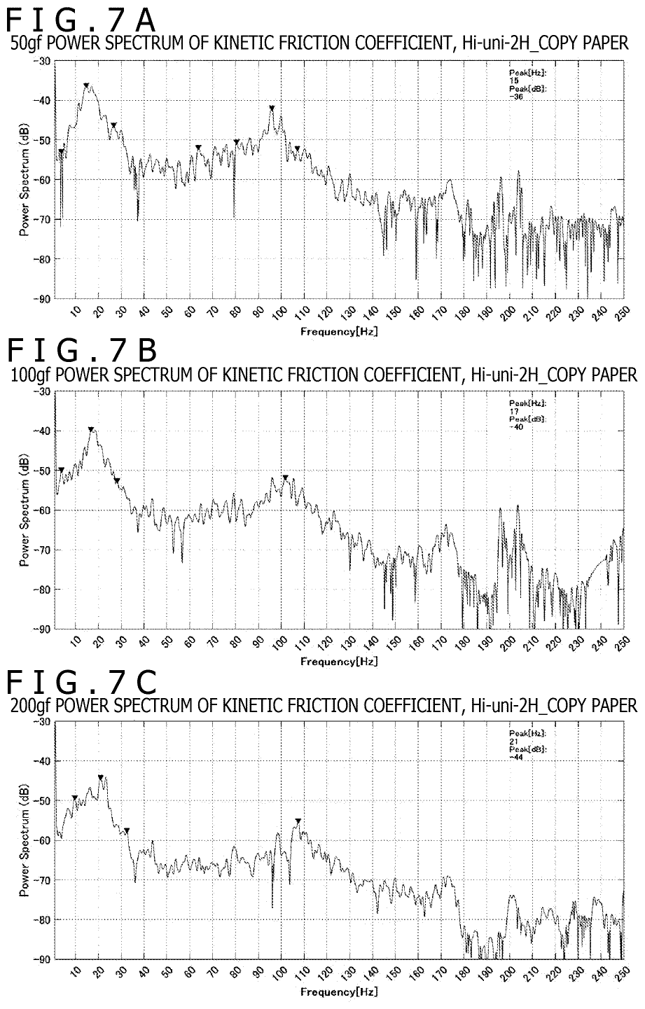

With reference to FIGS. 6B and 7B, it can be confirmed that the vibration frequency characteristics of the kinetic friction coefficient in the cases in which writing is executed on the copy paper with the pencil to which 100 gf is applied as the writing pressure are characteristics in which the peak of the magnitude of the vibration of the kinetic friction coefficient is exhibited at frequencies of 19 Hz and 17 Hz with the pencils having the core hardness of HB and 2H, respectively.

Moreover, with reference to FIGS. 6C and 7C, it can be confirmed that the vibration frequency characteristics of the kinetic friction coefficient in the cases in which writing is executed on the copy paper with the pencil to which 200 gf is applied as the writing pressure are characteristics in which the peak of the magnitude of the vibration of the kinetic friction coefficient is exhibited at frequencies of 22 Hz and 21 Hz with the pencils having the core hardness of HB and 2H, respectively.

With reference to FIGS. 4B, 4C, 5B, 5C, 6B, 6C, 7B, and 7C, it can be confirmed that the vibration of the kinetic friction coefficient is more suppressed in the vibration frequency characteristic of the kinetic friction coefficient as the writing pressure applied to the pencil becomes higher, and this tendency becomes weaker when the core of the pencil becomes harder.

From the above, it can be confirmed in this embodiment that the vibration frequency characteristics of the kinetic friction coefficient in the cases in which writing is executed on the copy paper with the pencil having the core harder than 2B in a state in which a writing pressure is applied in a range of 50 to 200 gf become characteristics in which the peak of the magnitude of the vibration of the kinetic friction coefficient is exhibited in a frequency range of 17±5 Hz. Further, even in the cases in which the core hardness is 2B or 4B, the peak of the magnitude of the vibration of the kinetic friction coefficient is exhibited in the frequency range of 17±5 Hz as long as the writing pressure is in a light range like a range of 50 to 100 gf. That is, the above-described ±Δ is set to ±Δ=±5 Hz in this embodiment.

With this frequency range, the characteristics in the cases in which the core hardness is 2B or 4B are not covered when the writing pressure exceeds 100 gf. However, by considering the hardness of the core body of the electronic pen 1, a writing feel similar to the writing feel in the case of the combination of the pencil and the copy paper can be obtained in the pen input device sheet of this embodiment even when such a frequency range is employed. Moreover, without having to consider the hardness of the core body of the electronic pen 1, considering the fact that the writing pressure applied when writing is executed on the pen input device sheet 100 with the electronic pen 1 is approximately 50 gf in general, a writing feel similar to the writing feel in the case of the combination of the pencil and the copy paper can be obtained in the pen input device sheet of this embodiment even when such a frequency range is employed.

On the basis of the above measurement result, in the first embodiment, the pen input device sheet 100 is configured such that the vibration frequency characteristic of the kinetic friction coefficient obtained when writing is executed on this pen input device sheet 100 with the electronic pen 1 matches the vibration frequency characteristic of the kinetic friction coefficient obtained when writing is executed on the copy paper with the above-described pencil.

In the first embodiment, the pen input device sheet 100 is configured to have the peak of the magnitude of the vibration of the kinetic friction coefficient in a predetermined frequency range, the frequency range of 17±5 Hz in this example, so that the vibration frequency characteristic of the kinetic friction coefficient regarding the pen input device sheet 100 obtained when the electronic pen 1 is moved on the writing input surface of the pen input device sheet 100 at a speed of 10 mm/second as a predetermined speed in a state in which a predetermined writing pressure, for example, a writing pressure of 50 gf, is applied matches the vibration frequency characteristic of the kinetic friction coefficient obtained when the pencil is moved on the copy paper under the same conditions (see FIGS. 4A, 5A, 6A, and 7A). The writing pressure applied to the electronic pen 1 when the vibration frequency characteristic of the kinetic friction coefficient of the pen input device sheet 100 is obtained is not limited to 50 gf, and may be either lower or higher than 50 gf.

A specific configuration example of the pen input device sheet 100 of the first embodiment for making such a configuration is described below.

### [Configuration Example of Pen Input Device Sheet 100 of First Embodiment]

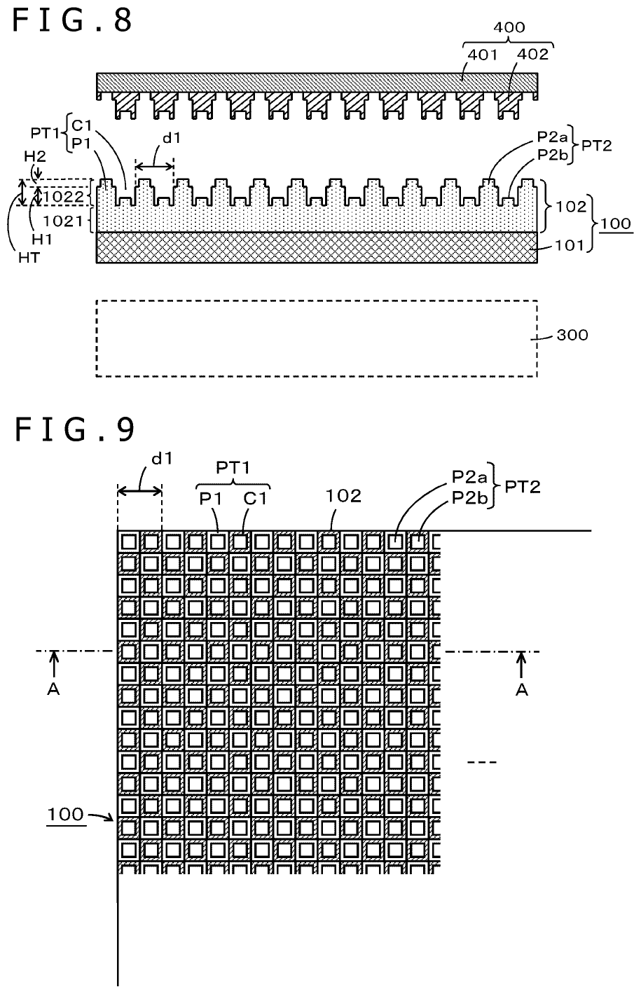

FIGS. 8 and 9 are conceptual diagrams for explaining a configuration example of the pen input device sheet 100 of the first embodiment. FIG. 9 is a diagram of the pen input device sheet 100 of the first embodiment as viewed in a thickness direction thereof from the side of the writing input surface to which writing input with the electronic pen 1 is made. FIG. 8 is a sectional view taken along line A-A in FIG. 9.

As depicted in FIG. 8, the pen input device sheet 100 of the first embodiment includes a base 101 and an elastic material layer 102 disposed on the base 101. A transparent optical material is adopted as an elastic material used for this elastic material layer, in the case of a terminal having the display device 202.

The base 101 includes a material harder than the elastic material of the elastic material layer 102, in this example, a polyethylene terephthalate (PET) resin. Further, in this example, the base 101 is a sheet-shaped component that covers the whole of the position detection region of the position detecting sensor 310 of the position detecting device 300 when the pen input device sheet 100 is disposed on the position detecting device 300.

In this embodiment, the elastic material layer 102 includes an elastic material, in this example, a polyurethane resin, with a thickness of, for example, 0.15 mm, and has a plurality of layer portions with different configurations (structures) in the thickness direction thereof. In this example, the plurality of layer portions in the elastic material layer 102 are a first layer portion 1021 and a second layer portion 1022. In this example, the layer portion has the first layer portion 1021 on the side of the base 101 (side of the position detecting sensor 310) and has the second layer portion 1022 on the side of the writing input surface to which writing input with the electronic pen 1 is made, which side is opposite to the side of the base 101.

The first layer portion 1021 of the elastic material layer 102 is a uniform polyurethane resin layer as depicted in FIG. 8. The second layer portion 1022 of the elastic material layer 102 is a layer having a first uneven pattern PT1 and a second uneven pattern PT2 as depicted in FIGS. 8 and 9.

In this case, in the first uneven pattern PT1, as depicted in FIGS. 8 and 9, projecting portions P1 and recessed portions C1 are formed along a direction orthogonal to the thickness direction of the layer (along a direction of a plane lying parallel to the sheet surface) in such a manner as to be alternately repeated, in this example, in a lateral direction and a longitudinal direction of the surface of the pen input device sheet 100. In FIG. 9, bottom surface portions of the recessed portions C1 are depicted with hatching in order to distinguish the projecting portions P1 and the recessed portions C1 of the first uneven pattern PT1 from each other.

The first uneven pattern PT1 forms a main factor in selection of the writing feel of the pen input device sheet 100 of this embodiment. In this embodiment, in particular, the total length of one projecting portion P1 and one recessed portion C1 is represented as d1 that corresponds to a parameter RSm of surface roughness (mean width of roughness profile elements) and that is the mean width of profile elements within a sampling length (mean interval of recesses and projections). In addition, the total height of one projecting portion P1 and one projecting portion P2a is represented as HT that corresponds to a parameter Rz of the surface roughness (maximum height; height from the lowest valley to the maximum peak within each sampling length) and that is the maximum height in the profile within the sampling length (maximum height of recess and projection). These d1 and HT are selected to exhibit the writing feel obtained in a case in which the target writing material (in this embodiment, pencil) is moved on the target writing medium (in this embodiment, copy paper).

In the pen input device sheet 100 of the first embodiment, the mean interval d1 of recesses and projections of the projecting portions P1 and the recessed portions C1 of the first uneven pattern PT1 is selected such that the vibration frequency characteristic of the kinetic friction coefficient of the pen input device sheet 100 matches the frequency that exhibits the peak in the vibration frequency characteristic of the kinetic friction coefficient obtained when a pencil is moved on copy paper (see FIGS. 4A, 5A, 6A, and 7A) and such that the maximum value of the peak waveform of the vibration of the kinetic friction coefficient is exhibited in the frequency range of 17±5 Hz. In addition, the maximum height HT of recess and projection is selected so as to exhibit such surface roughness that a sense of roughness when a pencil as an example of the writing material is moved on paper is obtained.

In the above description, “matches the frequency that exhibits the peak” may be causing the frequency that exhibits the peak to exist in a predetermined frequency range or be causing the frequency that exhibits the peak to be a frequency that coincides with or approximates a predetermined frequency.

In this embodiment, the mean interval d1 of recesses and projections of the first uneven pattern PT1 is deemed as the mean width of profile elements within the sampling length of the pen input device sheet 100, and is set to, for example, d1=0.5 to 0.6 mm. Further, the total height HT of the projecting portion P1 of the first uneven pattern PT1 and the projecting portion P2a of the second uneven pattern PT2 is selected as the maximum height in the profile within the sampling length of the pen input device sheet 100. The total height HT is set within a range of HT=9 to 20 μm, and is preferably set to H1=approximately 12.4 μm.

Moreover, in the second uneven pattern PT2, as depicted in FIGS. 8 and 9, projecting portions and recessed portions are formed to be repeated along a direction orthogonal to the thickness direction of the layer (along a direction of a plane lying parallel to the sheet surface) and in the lateral direction and the longitudinal direction of the surface of the pen input device sheet 100, as with the first uneven pattern PT1. In this embodiment, the second uneven pattern PT2 is formed to overlap the first uneven pattern PT1. The second uneven pattern PT2 is made as a pattern that is repeated at a specific regular interval or that forms an uneven shape irregularly disposed. In this example, the second uneven pattern PT2 is configured to be repeated at a specific regular interval.

That is, in this embodiment, as depicted in FIGS. 8 and 9, the second uneven pattern PT2 is configured such that recesses and projections are formed on both upper surfaces of the projecting portions P1 and bottom surfaces of the recessed portions C1 in the first uneven pattern PT1. In the example depicted in FIGS. 8 and 9, the projecting portions P2a with a size smaller than that of the projecting portions P1 (height H2 satisfies H2<H1) are formed at central portions of the upper surfaces of the projecting portions P1 of the first uneven pattern PT1. Further, projecting portions P2b with the same size as the projecting portions P2a are formed also at central portions of the bottom surfaces of the recessed portions C1 of the first uneven pattern PT1. Further, in the upper surface of each projecting portion P1 of the first uneven pattern PT1, a recess and a projection are formed by the projecting portion P2a and a peripheral portion thereof. In addition, in the bottom surface of each recessed portion C1 of the first uneven pattern PT1, a recess and a projection are formed by the projecting portion P2b and a peripheral portion thereof.

Therefore, in this embodiment, when a flat surface in which the first uneven pattern PT1 does not exist is assumed, the second uneven pattern PT2 is a pattern in which the projecting portions P2a and the projecting portions P2b smaller (including the height) than the projecting portions P1 of the first uneven pattern PT1 are formed with ½ of the mean interval d1 of recesses and projections of the first uneven pattern PT1 being the pitch of repetition.

That is, the second uneven pattern PT2 is formed with a mean interval of recesses and projections shorter than the mean interval d1 of recesses and projections of the first uneven pattern PT1, and is formed as recesses and projections with a size smaller than that of the recesses and projections of the first uneven pattern PT1.

The second uneven pattern PT2 acts to disperse the sharp peak waveform of the vibration frequency characteristic of the kinetic friction coefficient of the pen input device sheet 100, generated by the recesses and projections of the above-described first uneven pattern PT1, and form a peak waveform made broad in the vibration frequency distribution.

Moreover, in a case in which the pen input device sheet 100 is disposed over the display screen 202D, the second uneven pattern PT2 has an anti-glare property to suppress the lowering of visibility of a displayed image caused by reflection of ambient light by the surface of the pen input device sheet 100 or reflection of an image on the surface, and thus plays a role in improving the visibility of the displayed image.

A method for forming the first uneven pattern PT1 and the second uneven pattern PT2 of the second layer portion 1022 formed in the above-described manner is configured as follows.

In this example, a transfer film component 400 is used as depicted in FIG. 8. In this example, this transfer film component 400 is a component in which an uneven pattern corresponding to the first uneven pattern PT1 and the second uneven pattern PT2 of the second layer portion 1022 is formed on a sheet-shaped base film 401 by, in this example, ultraviolet (UV)-curable ink and a transferred uneven portion 402 (hard component) is formed through UV printing by UV curing. In the transferred uneven portion 402, the relation between recesses and projections is inverted from that of the first uneven pattern PT1 and the second uneven pattern PT2 of the second layer portion 1022. In addition, a mold release agent is applied on the surface of the uneven pattern of the transferred uneven portion 402 in the transfer film component 400. The method for forming the transferred uneven portion 402 is not limited to additive manufacturing like the UV printing. An aimed uneven shape may be formed by uneven coating onto a base film surface, kneading of a recess-projection forming material into the inside of a base film, formation of recesses and projections by pressurizing of a base film by a mold, or use of these methods in a combined manner.

Further, the side on which the transferred uneven portion 402 is formed in the base film 401 of the transfer film component 400 is pressed against the surface on the side opposite to the side of the base 101 in the elastic material layer 102, and is separated after the elastic material is cured. The second layer portion 1022 having the -described first uneven pattern PT1 and second uneven pattern PT2 is thus formed on the side opposite to the side of the base 101 in the elastic material layer 102.

The pen input device sheet 100 of the first embodiment created in the above-described manner is disposed over the display screen 202D and is used such that the side of the base 101 is set on the side of the display screen 202D. Therefore, the side of the second layer portion 1022 in which the first uneven pattern PT1 and the second uneven pattern PT2 are formed in the elastic material layer 102 is exposed to serve as the writing input surface to which writing input with the electronic pen 1 is made.

According to the pen input device sheet 100 of the first embodiment, a pen input device sheet having the vibration frequency characteristic of the kinetic friction coefficient close to the vibration frequency characteristic of the kinetic friction coefficient obtained with the target combination of a writing material and a writing medium can be obtained.

For example, when the writing material is a pencil having the core hardness of 4B, 2B, or HB and the writing medium is copy paper, as depicted in FIGS. 4A to 4C, 5A to 5C, and 6A to 6C, in the vibration frequency characteristics of the kinetic friction coefficient, the maximum value of the peak waveform tends to become not what is prominent in a spike manner from frequency ranges around the maximum value but an apex part of a broad waveform over several tens of hertz in the frequency distribution of the magnitude of the vibration in a vibration frequency range with a width of approximately 20 Hz including the maximum value of the peak waveform.

Thus, in the first embodiment, in a case of desiring to obtain the writing feel obtained when writing is executed on the copy paper with the pencil having the core hardness of 4B, 2B, or HB, the first uneven pattern PT1 of the second layer portion 1022 of the elastic material layer 102 is configured such that the frequency that exhibits the maximum value of the peak waveform of the vibration of the kinetic friction coefficient in the vibration frequency characteristic of the kinetic friction coefficient obtained when writing is executed with the electronic pen 1 on the pen input device sheet 100 of the first embodiment exists in the frequency range of 17±5 Hz as described above. Moreover, the second uneven pattern PT2 of the second layer portion 1022 of the elastic material layer 102 is configured with a mean interval of recesses and projections shorter than the mean interval of recesses and projections of the first uneven pattern PT1 and in such a manner as to have recesses and projections smaller than the recesses and projections of the first uneven pattern PT1.

That is, the uneven pattern of the UV-curable ink used in the formation of the transferred uneven portion 402 on the base film 401 of the transfer film component 400 is made as an uneven pattern corresponding to the first uneven pattern PT1 and the second uneven pattern PT2 of the above-described elastic material layer 102. In this case, due to the existence of the second uneven pattern PT2, the predetermined vibration frequency based on the first uneven pattern PT1 is dispersed into lower and higher frequencies.

Further, by selecting the line width, the formation pitch of the uneven pattern, and the like regarding the UV-curable ink as the example of the transferred uneven portion 402 formed on the base film 401 of the transfer film component 400, such that the frequency that exhibits the second peak of the vibration of the kinetic friction coefficient in the vibration frequency characteristic of the kinetic friction coefficient exists in a frequency range of 80±5 Hz, the vibration frequency characteristics of the kinetic friction coefficient obtained when the core hardness is 4B, 2B, or HB can be reproduced.

Further, in the case of the pencil having the core hardness of 2H, as depicted in FIGS. 7A to 7C, the frequency that exhibits the second largest peak of the vibration of the kinetic friction coefficient exists in a frequency range of 100±Δ Hz (Δ is, for example, 10).

Thus, in a case of desiring to obtain the writing feel obtained when writing is executed on paper with the pencil having the core hardness of 2H, the pen input device sheet 100 of the first embodiment is configured in the following manner. The first uneven pattern PT1 is configured as in the above description. The formation pitch and the like of the second uneven pattern PT2 are selected such that the frequency that exhibits the second peak of the vibration of the kinetic friction coefficient in the vibration frequency characteristic of the kinetic friction coefficient exists in the frequency range of 100±10 Hz.

As above, according to the pen input device sheet 100 of the above-described first embodiment, when writing input is made with the electronic pen on this pen input device sheet 100, a feeling (writing feel or sense of writing) similar to that obtained when writing input is made with a pencil on copy paper can be obtained. In addition, even a sense of roughness in writing in the relation between the pencil and the paper can be obtained.

Moreover, according to the pen input device sheet 100 of the first embodiment, the elastic material layer 102 is configured to have the first uneven pattern PT1 and the second uneven pattern PT2. Due to this, the configuration is made to match not only the maximum value of the peak waveform of the vibration of the kinetic friction coefficient in the vibration frequency characteristic of the kinetic friction coefficient in the case of the target writing material and the target writing medium but also a broad waveform of the frequency distribution of the magnitude of the vibration including vibration frequencies around the maximum value of the peak waveform. Due to this, according to the pen input device sheet 100 of the first embodiment, the writing feel can be comparatively easily brought close to the writing feel obtained with the target combination of the writing material and the writing medium.

In addition, according to the pen input device sheet 100 of the first embodiment, due to the existence of the second uneven pattern PT2, it is possible to provide an anti-glare effect to suppress the occurrence of reflection of ambient light or reflection of an image like one on what is generally called a specular surface in the pen input device sheet 100. Thus, the visibility of a displayed image can be improved.

In the pen input device sheet 100 of the above-described first embodiment, the first uneven pattern PT1 and the second uneven pattern PT2 are configured to be repeated along directions parallel to the lateral direction and the longitudinal direction of the surface of the pen input device sheet 100. However, the first uneven pattern PT1 and the second uneven pattern PT2 may be formed not in parallel to the lateral direction and the longitudinal direction of the surface of the pen input device sheet 100 but in directions intersecting the lateral direction and the longitudinal direction, or do not have to be patterns regularly arranged in a certain direction if a predetermined mean interval of recesses and projections is satisfied.

Further, although the elastic material layer 102 includes a urethane resin in the pen input device sheet 100 of the above-described first embodiment, it is obvious that the material of the elastic material layer 102 is not limited to the urethane resin. Moreover, it is also obvious that the material of the transferred uneven portion 402 of the transfer film component 400 is not limited to the UV-curable ink.

### Surface Roughness of Pen Input Device Sheet 100 of First Embodiment

In the pen input device sheet 100 of the first embodiment, as described above, the second uneven pattern PT2 with small recesses and projections exists in the first uneven pattern PT1 with large recesses and projections, and these recesses and projections have a predetermined relation. Due to this, the desired writing feel (sense of writing) can be obtained, and the anti-glare property is implemented.

In order to specify the relation between the recesses and projections of the first uneven pattern PT1 and those of the second uneven pattern PT2, in this example, surface roughness due to the respective recesses and projections is measured, and the relation is defined by using the measurement results of both.

Here, the surface roughness due to the recesses and projections of the first uneven pattern PT1 and the surface roughness due to the recesses and projections of the second uneven pattern PT2 were separately measured by varying measurement conditions. In this case, several samples successfully confirmed as having the favorable sense of writing and the favorable anti-glare property were prepared as the pen input device sheet 100 as the measurement target, and the surface roughness was measured about them.

In this case, in this example, the transfer film component 400 was formed by processing of clamping its material by two rotating drums to make recesses and projections. As a specification of finishing of the uneven pattern, a matte finish was employed. Therefore, two kinds of transfer film components 400 different in manufacturing method for matte treatment were used, and samples MP1 and MP2 of the pen input device sheet with the matte finish were prepared.

Moreover, in this example, concerning the sample MP2, the following three kinds of samples were prepared: the sample MP2 (standard) prepared by using the transfer film component 400 manufactured with the standard first uneven pattern PT1; the sample MP2 (shallow hollowing) in which the depth of recesses and projections of the first uneven pattern PT1 was intentionally set shallow; and the sample MP2 (deep hollowing) in which the depth of recesses and projections of the first uneven pattern PT1 was intentionally set deep. That is, the measurement of the surface roughness of the pen input device sheet 100, described below, was executed about the above-described four kinds of samples MP1, MP2 (standard), MP2 (shallow hollowing), and MP2 (deep hollowing).

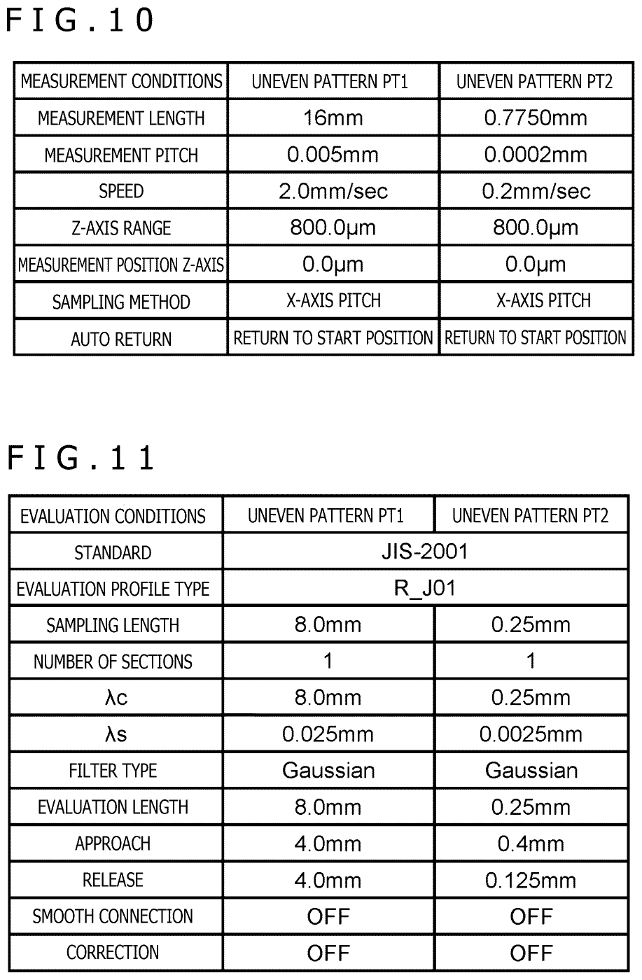

Measurement conditions and evaluation conditions of the surface roughness in this case are depicted in FIGS. 10 and 11. In FIG. 11, “λc” and “λs” are each a cutoff value. That is, when a surface is measured by a measuring instrument, a measured profile in which various wavelengths are mixed is obtained regarding the surface shape. A profile obtained by removing unnecessary short wavelength components such as noise from this measured profile is referred to as a primary profile, and a value to decide how short the wavelengths to be removed are is the cutoff value λs. Further, a profile obtained by removing shapes with short wavelengths from the measured profile is referred to as a waviness profile, and a value to decide how short the wavelengths of the shapes to be removed are is the cutoff value λc. At this time, the relation between the lengths of the wavelengths to be cut off satisfies λc>λs. Moreover, a profile obtained by removing shapes with long wavelengths (waviness profile) from the primary profile is referred to as a roughness profile. Wavelengths shorter than the cutoff value λc are ignored for the waviness, whereas wavelengths longer than the cutoff value λc are ignored for the roughness. These cutoff value λc and cutoff value λs are well-known values (for example, refer to URL (https://d-monoweb.com/expert_column/surface-roughness-parameter/)).

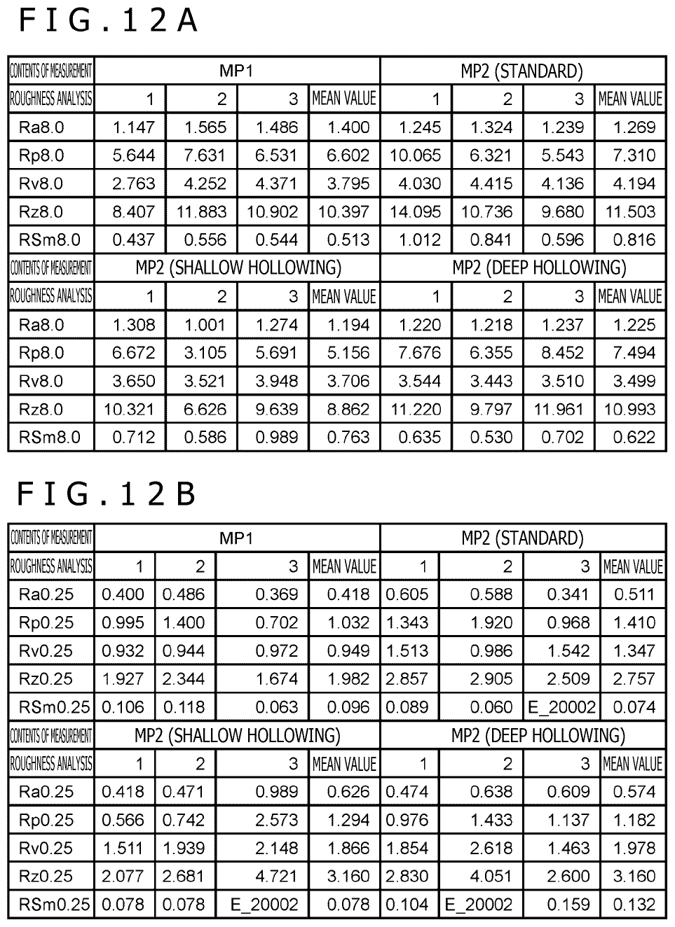

FIGS. 12A and 12B depict results of the measurement executed about the four samples MP1, MP2 (standard), MP2 (shallow hollowing), and MP2 (deep hollowing) under the measurement conditions and the evaluation conditions depicted in FIGS. 10 and 11. FIG. 12A is a table indicating the measurement result about the first uneven pattern PT1 of the pen input device sheet 100. FIG. 12B is a table indicating the measurement result about the second uneven pattern PT2 of the pen input device sheet 100.

In the tables of FIGS. 12A and 12B, a parameter Ra is an arithmetic mean roughness, is a mean value of absolute value deviation from a mean line, and is calculated from the roughness profile. A parameter Rp is the highest part when part of the roughness profile is extracted with the sampling length, that is, the maximum peak height. A parameter Rv is the deepest part when part of the roughness profile is extracted with the sampling length, that is, the maximum valley depth. A parameter Rz is the maximum height and is obtained as the sum of the maximum peak height Rp and the maximum valley depth Rv. Moreover, a parameter RSm is the mean width of roughness profile elements and is a mean value of the interval of the peak-valley cycle obtained from intersections at which the roughness profile intersects the mean line.

Numerical values on the right of the respective parameters Ra, Rp, Rv, Rz, and RSm denote the cutoff value λc in the evaluation conditions. That is, in FIGS. 12A and 12B, parameters Ra8.0, Rp8.0, Rv8.0, Rz8.0, and RSm8.0 are values of the parameters Ra, Rp, Rv, Rz, and RSm in the case of the cutoff value λc=8.0 mm. Further, parameters Ra0.25, Rp0.25, Rv0.25, Rz0.25, and RSm0.25 are values of the parameters Ra, Rp, Rv, Rz, and RSm in the case of the cutoff value λc=0.25 mm.

From the measurement results indicated in FIGS. 12A and 12B, that the first uneven pattern PT1 and the second uneven pattern PT2 in the pen input device sheet 100 of the embodiment are in an appropriate relation can be prescribed as follows.

Further, in this example, as the relation between the first uneven pattern PT1 and the second uneven pattern PT2 in the pen input device sheet 100 of the embodiment, the ratio is obtained between each of the parameters Ra8.0, Rp8.0, Rv8.0, Rz8.0, and RSm8.0 measured with the cutoff value λc=8.0 mm and a corresponding one of the parameters Ra0.25, Rp0.25, Rv0.25, Rz0.25, and RSm0.25 measured with the cutoff value λc=0.25 mm.

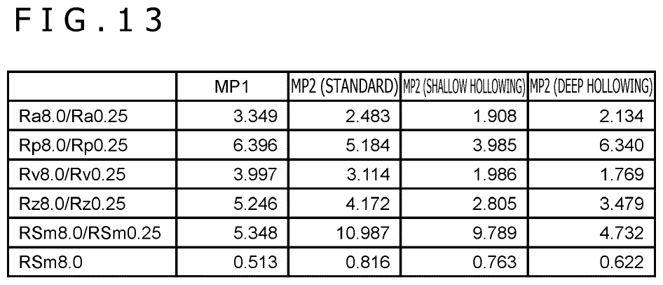

FIG. 13 depicts a table of values derived by obtaining, from FIGS. 12A and 12B, the ratios of the respective parameters, that is, Ra8.0/Ra0.25, Rp8.0/Rp0.25, Rv8.0/Rv0.25, Rz8.0/Rz0.25, and RSm8.0/RSm0.25, regarding the four kinds of samples MP1, MP2 (standard), MP2 (shallow hollowing), and MP2 (deep hollowing). Moreover, FIG. 13 indicates the value (mean value) of the parameter RSm8.0 measured about each of the four kinds of samples MP1, MP2 (standard), MP2 (shallow hollowing), and MP2 (deep hollowing).

From this FIG. 13, that the first uneven pattern PT1 and the second uneven pattern PT2 in the pen input device sheet 100 of the embodiment are in an appropriate relation can be prescribed as follows.

Specifically, the parameter RSm8.0 when the measurement was executed with the cutoff value λc=8.0 mm falls within a range of 0.513 to 0.816, and the ratio of the parameter Ra8.0 measured with the cutoff value λc=8.0 mm to the parameter Ra0.25 measured with the cutoff value λc=0.25 mm, that is, Ra8.0/Ra0.25, falls within a range of 1.908 to 3.349. This can be deemed as one condition indicating that the uneven patterns PT1 and PT2 are in an appropriate relation.

Further, the parameter RSm8.0 when the measurement was executed with the cutoff value λc=8.0 mm falls within a range of 0.513 to 0.816, and the ratio of the parameter Rv8.0 measured with the cutoff value λc=8.0 mm to the parameter Rv0.25 measured with the cutoff value λc=0.25 mm, that is, Rv8.0/Rv0.25, falls within a range of 1.769 to 3.997. This can also be deemed as one condition indicating that the uneven patterns PT1 and PT2 are in an appropriate relation.

### Modifications of Pen Input Device Sheet 100 of First Embodiment

In the pen input device sheet 100 of the above-described first embodiment, the configuration in which the elastic material layer 102 is formed on the base 101 is employed in order to allow detachment from the display screen 202D. However, when the detachment is not considered, the configuration may be made such that the part of the base 101 is changed to an adhesive layer and the pen input device sheet 100 is attached onto a surface of the display screen 202D or the like by this adhesive layer. Alternatively, the configuration may be made such that an adhesive layer is disposed on the surface of the base 101 on the side opposite to the side on which the elastic material layer 102 is formed and the pen input device sheet 100 is attached onto the surface of the display screen 202D or the like by this adhesive layer.

Other examples of specific configuration examples (structure examples) of the pen input device sheet of the first embodiment are described below as modifications with reference to the drawings.

### <First Modification>

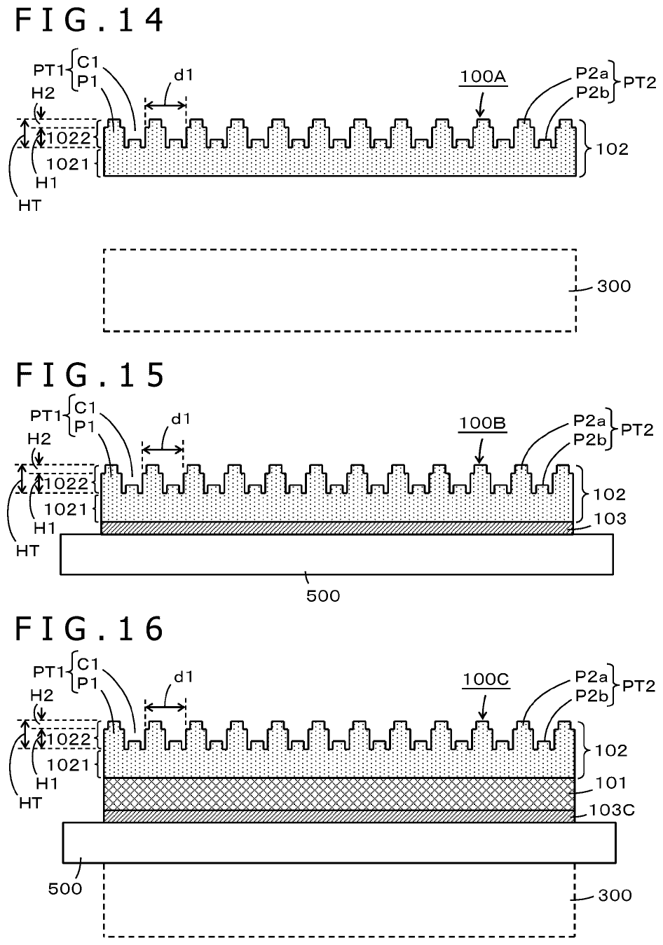

FIG. 14 is a conceptual diagram for explaining a specific configuration example (structure example) of a pen input device sheet 100A of a first modification. In the pen input device sheet 100A of this example of FIG. 14, a constituent part same as that of the pen input device sheet 100 of the above-described first embodiment is given the same reference symbol, and detailed description thereof is omitted.

The pen input device sheet 100A of the first modification has a configuration obtained by removing the base 101 from the pen input device sheet 100 of the first embodiment. That is, in the pen input device sheet 100A of the first modification, the pen input device sheet 100A is formed by the elastic material layer 102 alone.

Even with the above configuration, when writing input is made with the electronic pen on the pen input device sheet 100A of the first modification, a feeling (writing feel or sense of writing) similar to that of the pen input device sheet 100 of the above-described first embodiment can be obtained by holding down the pen input device sheet 100A by a hand or tape such that the pen input device sheet 100A may be kept from moving, as in the case of paper.

### <Second Modification>

FIG. 15 is a conceptual diagram for explaining a specific configuration example (structure example) of a pen input device sheet 100B of a second modification. Also in the pen input device sheet 100B of this example of FIG. 15, a constituent part same as that of the pen input device sheet 100 of the above-described first embodiment is given the same reference symbol, and detailed description thereof is omitted.

The pen input device sheet 100B of the second modification is an example in which the base 101 of the pen input device sheet 100 of the first embodiment is changed to an adhesive layer 103. That is, the pen input device sheet 100B of the second modification is configured by disposing the elastic material layer 102 and the adhesive layer 103 on the surface of the elastic material layer 102 on the side of the position detecting device 300 as depicted in FIG. 15. Then, the pen input device sheet 100B is attached onto an upper surface of a glass top plate 500 of the display screen 202D of the tablet-type information terminal 200 by the adhesive layer 103.

Also in the configuration of the second modification described above, when writing input is made with the electronic pen on the pen input device sheet 100B, a feeling (writing feel or sense of writing) similar to that of the pen input device sheet 100 of the above-described first embodiment can be obtained without holding down the pen input device sheet 100B by a hand or tape because the pen input device sheet 100B is attached onto the upper surface of the glass top plate 500.

### <Third Modification>

FIG. 16 is a conceptual diagram for explaining a specific configuration example (structure example) of a pen input device sheet 100C of the third modification. In the pen input device sheet 100C of this example of FIG. 16, a constituent part same as that of the pen input device sheet 100 of the above-described first embodiment is given the same reference symbol, and detailed description thereof is omitted.

The pen input device sheet 100C of the third modification is an example in which an adhesive layer 103C is added to the surface of the base 101 on the side opposite to the side of the elastic material layer 102 in the pen input device sheet 100 of the above-described first embodiment.

The pen input device sheet 100C of the third modification has a configuration in which the adhesive layer 103C is disposed on the surface of the base 101 on the side (side of the position detecting device 300) opposite to the surface on the side of the elastic material layer 102 as depicted in FIG. 16. Then, the pen input device sheet 100C is disposed to be attached onto the upper surface of the glass top plate 500 of the display screen 202D of the tablet-type information terminal 200 by the adhesive layer 103C.

When writing input is made with the electronic pen on the pen input device sheet 100C of the third modification with the above configuration, a feeling (writing feel or sense of writing) similar to that of the pen input device sheet 100 of the above-described first embodiment can be obtained.

It has been explained that, in the pen input device sheet 100 of the first embodiment described above, the second uneven pattern PT2 is formed to overlap the first uneven pattern PT1 in the second layer portion 1022. However, in a case in which the second uneven pattern PT2 is considered as being divided into an uneven pattern composed of the projecting portions P2a formed on the projecting portions P1 of the first uneven pattern PT1 and recessed portions around them and another uneven pattern composed of the projecting portions P2b formed on the recessed portions C1 of the first uneven pattern PT1 and recessed portions around them, the uneven pattern composed of the projecting portions P2a formed on the projecting portions P1 of the first uneven pattern PT1 and the recessed portions around them can be regarded as a layer portion different from the second layer portion 1022. In this case, the elastic material layer 102 can be considered as a component having three layer portions.

### Configuration Example of Pen Input Device Sheet 100D of Second Embodiment

In the pen input device sheet 100 of the above-described first embodiment, the first uneven pattern and the second uneven pattern are formed to overlap in the second layer portion 1022 of the elastic material layer 102. However, it is also possible to form the first uneven pattern and the second uneven pattern in layer portions different from each other in an elastic material layer having a plurality of layer portions. A pen input device sheet 100D of a second embodiment is one example of a case in which a configuration is made in such a manner.

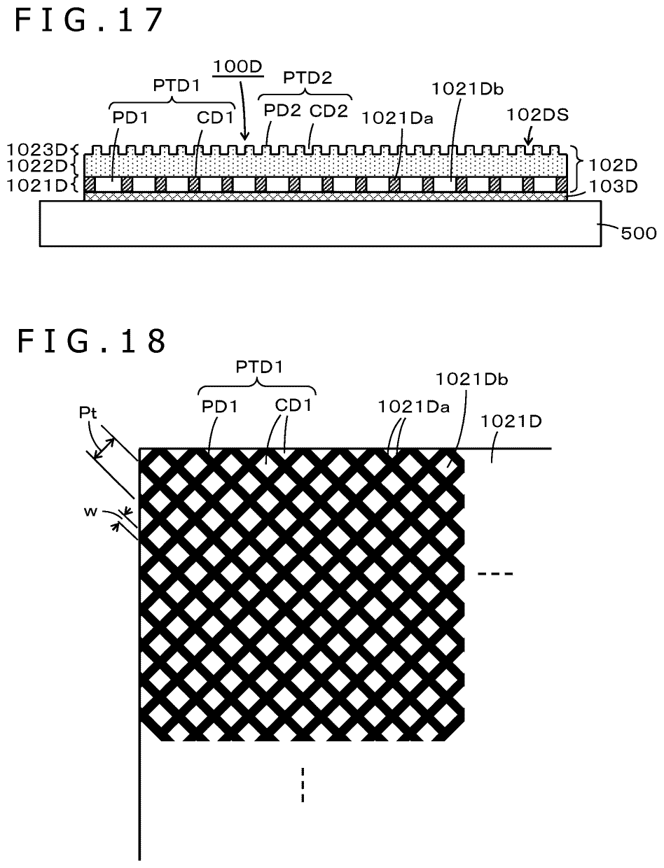

FIGS. 17 and 18 are conceptual diagrams for explaining a configuration example of the pen input device sheet 100D of the second embodiment. In FIG. 17, the pen input device sheet 100D is depicted by a sectional view as in FIG. 8. The pen input device sheet 100D of the second embodiment is fixed onto the smooth glass top plate 500 serving as a support body that simulates a pen tablet terminal casing or a display device, by a sheet-shaped adhesive layer 103D. In FIG. 17, the position detecting device 300 is omitted.

As depicted in FIG. 17, the pen input device sheet 100D of the second embodiment includes the adhesive layer 103D and an elastic material layer 102D disposed on the adhesive layer 103D.

For the elastic material layer 102D, as a material having elasticity, a polyvinyl chloride (PVC) sheet having a film thickness of 0.1 mm is used in this example. In the second embodiment, the elastic material layer 102D is configured to have a plurality of layer portions with different configurations (structures) in the thickness direction thereof, in this example, a first layer portion 1021D on the side of the adhesive layer 103D, a second layer portion 1022D formed on the first layer portion 1021D on the side opposite to the side of the adhesive layer 103D, and a third layer portion 1023D formed on the second layer portion 1022D.

Here, as an example of the difference among the configurations (structures) of the first layer portion 1021D, the second layer portion 1022D, and the third layer portion 1023D, they are different from each other in the density per unit volume and/or different from each other in the hardness per unit volume. The elastic material layer 102D is disposed on one surface of the sheet-shaped adhesive layer 103D, and an exposed surface 102DS of the elastic material layer 102D on the side opposite to the side of the adhesive layer 103D is used as a writing input surface to which writing input with the electronic pen 1 is made.

In the pen input device sheet 100D of the second embodiment, the second layer portion 1022D of the elastic material layer 102D is a layer portion composed of uniform PVC.

Moreover, the first layer portion 1021D of the elastic material layer 102D is configured to have a first uneven pattern PTD1 in which recessed portions CD1 and projecting portions PD1 are alternately repeated along a direction orthogonal to the thickness direction of the elastic material layer 102D (along a direction of a plane lying parallel to the sheet surface of the first layer portion 1021D). The first uneven pattern PTD1 forms a main factor in selection of the writing feel of the pen input device sheet 100D of the second embodiment, as with the first uneven pattern PT1 of the pen input device sheet 100 of the first embodiment.

In this example, the projecting portions PD1 of the first uneven pattern PTD1 of the first layer portion 1021D are formed by a hard component 1021Da composed of a material harder than that of the second layer portion 1022D. In this example, the hard component 1021Da is composed of a UV-curable material. In this example, the hard component 1021Da is formed as a lattice-shaped pattern like one depicted in FIG. 18. Further, in this example, the recessed portions CD1 of the first uneven pattern PTD1 of the first layer portion 1021D are made as spaces 1021 Db that are not filled with a material (that is, spaces formed of air). In this case, tips of the projecting portions PD1 forming the first uneven pattern PTD1 of the first layer portion 1021D which tips are on the side of the adhesive layer 103D are made to abut against the one surface of the adhesive layer 103D. As above, the first layer portion 1021D has the first uneven pattern PTD1 in which the recessed portions CD1 have the space 1021 Db of air, and thus is a layer having elasticity in the thickness direction.

As is understood from the above configuration, in this example, the first layer portion 1021D and the second layer portion 1022D are different from each other in both the density and the hardness per unit volume. Although the hard component 1021Da is depicted by a thick black line in order to clarify the illustration in FIG. 18, this hard component 1021Da may be composed of a transparent material.

The third layer portion 1023D of the elastic material layer 102D is made as a layer portion having a second uneven pattern PTD2 formed on the second layer portion 1022D. Projecting portions PD2 of the second uneven pattern PTD2 are made as portions monolithic with the second layer portion 1022D and are composed of PVC. Moreover, recessed portions CD2 are made as spaces that are not filled with a material. That is, the third layer portion 1023D is exposed in the exposed surface 102DS of the elastic material layer 102D on the side opposite to the side of the adhesive layer 103D.

Further, also in the second embodiment, the second uneven pattern PTD2 of the third layer portion 1023D of the elastic material layer 102D is configured to have a mean interval of recesses and projections shorter than the mean interval of recesses and projections of the first uneven pattern PTD1 and have recesses and projections smaller than the recesses and projections of the first uneven pattern PTD1.

As with the second uneven pattern PT2 of the pen input device sheet 100 of the above-described first embodiment, the second uneven pattern PTD2 of the third layer portion 1023D acts to disperse the sharp peak waveform of the vibration frequency characteristic of the kinetic friction coefficient of the pen input device sheet 100D, generated by the recesses and projections of the first uneven pattern PTD1, and form a peak waveform made broad in the vibration frequency distribution. In addition, the second uneven pattern PTD2 has an anti-glare property and thus plays a role in improving the visibility of a displayed image in the pen input device sheet 100D.

One example of a manufacturing method for the pen input device sheet 100D of the second embodiment is as follows. The first uneven pattern PTD1 of the first layer portion 1021D of the elastic material layer 102D of the pen input device sheet 100D of the second embodiment is formed in the following manner.

On the surface of the second layer portion 1022D with a PVC sheet shape on the side of disposing of the adhesive layer 103D in the elastic material layer 102D, a lattice-shaped pattern corresponding to the lattice-shaped pattern of the first uneven pattern PTD1 is UV-printed as depicted in FIG. 18 by a UV-curable ink (ink of a UV-curable type), and the lattice-shaped pattern of the hard component 1021Da is formed by UV curing. In this case, in this example, the lattice-shaped pattern formed by the hard component 1021Da is formed in a state in which the lines that form the lattice and have been made by the UV-curable ink are inclined by 45 degrees with respect to the lateral direction and the longitudinal direction of the rectangular position detection region.

At this time, the parts of the spaces 1021 Db of air corresponding to the positions at which the UV-curable ink of the hard component 1021Da UV-printed on the second layer portion 1022D does not exist become the recessed portions CD1 of the first uneven pattern PTD1 of the first layer portion 1021D of the elastic material layer 102D, and the parts of the hard component 1021Da corresponding to the positions at which the UV-curable ink exists become the projecting portions PD1 of the first uneven pattern PTD1 of the first layer portion 1021D of the elastic material layer 102D.

The second uneven pattern PTD2 on the side of the exposed surface 102DS on the second layer portion 1022D of the elastic material layer 102D of the pen input device sheet 100D of the second embodiment is formed by, for example, using a transfer film component, as in the first embodiment. In this case, in the transfer film component, an uneven pattern corresponding to the second uneven pattern PTD2 is formed by a material harder than the material of the second layer portion 1022D of the elastic material layer 102D. In addition, the transfer film component is pressed against the second layer portion 1022D in a state in which the second layer portion 1022D is softened by heat or the like. The second uneven pattern PTD2 is thus formed. The formation of the second uneven pattern PTD2 may be executed either before or after formation of the first uneven pattern PTD1 in the first layer portion.

In this case, as in the first embodiment, the second uneven pattern PTD2 is formed with a mean interval of recesses and projections shorter than the mean interval d1 of recesses and projections of the first uneven pattern PTD1, and is formed as recesses and projections with a size smaller than that of the recesses and projections of the first uneven pattern PTD1.

Further, the second uneven pattern PTD2 acts to disperse the sharp peak waveform of the vibration frequency characteristic of the kinetic friction coefficient of the pen input device sheet 100D, generated by the recesses and projections of the first uneven pattern PTD1, and form a peak waveform made broad in the vibration frequency distribution. In addition, the second uneven pattern PTD2 has an anti-glare effect and thus plays a role in improving the visibility of a displayed image. These effects are also similar to those of the first embodiment.

Moreover, the sheet-shaped adhesive layer 103D is attached onto the surface of the first layer portion 1021D of the elastic material layer 102D of the pen input device sheet 100D of the second embodiment, the surface being on the side opposite to the side of the second layer portion 1022D. This forms the pen input device sheet 100D of the second embodiment.

Moreover, in the pen input device sheet 100D of the second embodiment, a line width w (see FIG. 18) of the UV-curable ink of the lattice-shaped pattern for forming the first uneven pattern PTD1 and a formation pitch Pt (see FIG. 18) of the lattice of the lattice-shaped pattern are selected such that the vibration frequency characteristic of the kinetic friction coefficient of the pen input device sheet 100D matches the vibration frequency characteristic of the kinetic friction coefficient obtained when a pencil is moved on copy paper (see FIGS. 4A, 5A, 6A, and 7A) and such that the maximum value of the peak waveform of the vibration of the kinetic friction coefficient is exhibited in the frequency range of 17±5 Hz.

In the second embodiment, the lattice-shaped pattern is formed by the UV-curable ink such that the line width w of the UV-curable ink is set to w=0.11 to 0.15 mm and the formation pitch Pt of the lattice of the lattice-shaped pattern is set to Pt=0.4 to 0.5 mm.

It has been confirmed that the characteristics in which the maximum value of the peak waveform of the vibration of the kinetic friction coefficient exists in the range of the frequency of 17±5 Hz in the vibration frequency characteristic of the kinetic friction coefficient, as in the cases of FIGS. 4A to 7A, are obtained when writing input is made with the electronic pen 1 at, in this example, a speed of 10 mm/second on the surface on the side of the exposed surface 102DS in the second layer portion 1022D of the pen input device sheet 100D of the second embodiment while a predetermined writing pressure is applied.

Moreover, it has been confirmed that a feeling (writing feel or sense of writing pressure (particularly, sense of roughness)) equivalent or close to that obtained when writing is executed on copy paper with a pencil is obtained when a user grasps the electronic pen 1 and makes writing input on the pen input device sheet 100D of the second embodiment.

Also with the pen input device sheet 100D of the above-described second embodiment, when writing input is made with the electronic pen 1 on the pen input device sheet 100D, a feeling (writing feel or sense of writing) similar to that obtained when writing input is made with a pencil on copy paper can be obtained. Further, even a sense of roughness in writing in the relation between the pencil and the paper can be obtained. In addition, the pen input device sheet 100D has an anti-glare effect and can improve the visibility of a displayed image.

Also in the pen input device sheet 100D of the second embodiment, modifications similar to those of the pen input device sheet 100 of the above-described first embodiment, such as changing the part of the adhesive layer 103D to a base, are possible.

### Configuration Example of Pen Input Device Sheet 100E of Third Embodiment

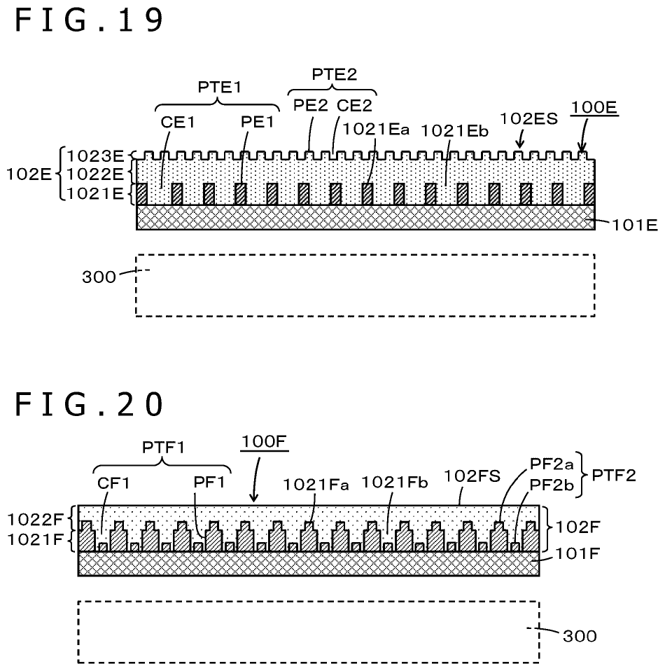

FIG. 19 is a conceptual diagram for explaining a specific configuration example (structure example) of a pen input device sheet 100E of a third embodiment. In FIG. 19, the pen input device sheet 100E is depicted by a sectional view as in FIGS. 8 and 17. The pen input device sheet 100E of the third embodiment corresponds to a configuration example obtained by, in the pen input device sheet 100D of the second embodiment, changing the elastic material to a polyurethane resin, filling the recessed portions CD1 of the first uneven pattern PTD1 of the first layer portion 1021D with the elastic material, and disposing a base 101E instead of the adhesive layer 103D. The base 101E is composed of a PET resin in this example.

Also in the pen input device sheet 100E of the third embodiment, an elastic material layer 102E has a plurality of layer portions with different configurations (structures) in the thickness direction thereof as in the second embodiment. Moreover, in this example, the elastic material layer 102E is configured to have, as the plurality of layer portions, a first layer portion 1021E on the side of the base 101E, a second layer portion 1022E formed on the first layer portion 1021E on the side opposite to the side of the base 101E, and a third layer portion 1023E formed on the second layer portion 1022E.

In the pen input device sheet 100E of the third embodiment, as an example of the difference among the configurations (structures) of the first layer portion 1021E, the second layer portion 1022E, and the third layer portion 1023E, they are different from each other in the density per unit volume and/or different from each other in the hardness per unit volume.

In the pen input device sheet 100E of the third embodiment of the example in FIG. 19, the second layer portion 1022E of the elastic material layer 102E is a layer composed only of a uniform polyurethane resin. Further, the first layer portion 1021E is configured to have a first uneven pattern PTE1 in which recessed portions CE1 and projecting portions PE1 are alternately repeated along a direction orthogonal to the thickness direction of the layer (along a direction of a plane lying parallel to an exposed surface 102ES of the pen input device sheet 100E).

The first uneven pattern PTE1 of the first layer portion 1021E of the elastic material layer 102E in the pen input device sheet 100E of the third embodiment is a lattice-shaped pattern that is formed on the base 101E in a manner similar to the case of the first uneven pattern PTD1 of the first layer portion of the pen input device sheet 100D of the second embodiment and that is composed of a UV-curable material (see FIG. 18). Moreover, in this case, the recessed portions CE1 of the first uneven pattern PTE1 of the first layer portion 1021E are filled with a polyurethane resin same as that of the second layer portion 1022E.

Specifically, the projecting portions PE1 of the first uneven pattern PTE1 are formed by a hard component 1021Ea composed of a UV-curable material, and the recessed portions CE1 are filled with an elastic material sufficiently softer than the UV-curable material, in this example, the polyurethane resin. The third embodiment is different from the second embodiment in that the recessed portions CE1 of the first uneven pattern PTE1 of the first layer portion 1021E are not spaces of air but filled with the polyurethane resin softer than the hard component 1021Ea composed of the UV-curable material. As above, the first layer portion 1021E has the first uneven pattern PTE1 in which the recessed portions CE1 are filled with the elastic material, and thus is a layer having elasticity in the thickness direction.

The third layer portion 1023E of the elastic material layer 102E is a layer portion having a second uneven pattern PTE2 formed on the second layer portion 1022E. In this example, projecting portions PE2 of the second uneven pattern PTE2 are made as portions monolithic with the second layer portion 1022E and are composed of the polyurethane resin. Further, recessed portions CE2 of the second uneven pattern PTE2 are made as spaces that are not filled with a material. In addition, the third layer portion 1023E is exposed in the exposed surface 102ES of the elastic material layer 102E on the side opposite to the side of the base 101E.

Also in the third embodiment, the second uneven pattern PTE2 of the third layer portion 1023E of the elastic material layer 102E is configured to have an interval that is a mean interval of recesses and projections shorter than the mean interval of recesses and projections of the first uneven pattern PTE1 and have recesses and projections smaller than the recesses and projections of the first uneven pattern PTE1.

The second uneven pattern PTE2 of the third layer portion 1023E of the elastic material layer 102E of the pen input device sheet 100E of the third embodiment is formed by using a transfer film component as in the first embodiment. In this case, in the transfer film component, an uneven pattern corresponding to the second uneven pattern PTE2 is formed by a hard resin material or the like harder than the polyurethane resin, and the transfer film component is pressed against the elastic material layer 102E from the writing input surface side. The second uneven pattern PTE2 is thus formed.

As with the second uneven pattern PT2 of the pen input device sheet 100 of the above-described first embodiment, the second uneven pattern PTE2 of the third layer portion 1023E acts to disperse the sharp peak waveform of the vibration frequency characteristic of the kinetic friction coefficient of the pen input device sheet 100E, generated by the recesses and projections of the first uneven pattern PTE1, and form a peak waveform made broad in the vibration frequency distribution. In addition, the second uneven pattern PTE2 has an anti-glare property and plays a role in improving the visibility of a displayed image in the pen input device sheet 100E.

Also with the pen input device sheet 100E of the above-described third embodiment, when writing input is made with the electronic pen 1 on the pen input device sheet 100E, a feeling (writing feel or sense of writing) similar to that obtained when writing input is made with a pencil on copy paper can be obtained. Further, even a sense of roughness in writing in the relation between the pencil and the paper can be obtained. In addition, the pen input device sheet 100E has an anti-glare effect and can improve the visibility of a displayed image.

Also in the pen input device sheet 100E of the third embodiment, modifications similar to those of the pen input device sheet 100 of the above-described first embodiment, such as changing the part of the base 101E to an adhesive layer, are possible.

### Configuration Example of Pen Input Device Sheet 100F of Fourth Embodiment

FIG. 20 is a conceptual diagram for explaining a specific configuration example (structure example) of a pen input device sheet 100F of a fourth embodiment. In FIG. 20, the pen input device sheet 100F is depicted by a sectional view as in FIGS. 8, 17, and 19.

In the pen input device sheet 100F of the fourth embodiment, a second layer portion 1022F of an elastic material layer 102F is a layer composed only of a uniform polyurethane resin as with the pen input device sheet 100E of the third embodiment. However, in the pen input device sheet 100F of the fourth embodiment, a layer portion corresponding to the third layer portion 1023E having the second uneven pattern PTE2 of the pen input device sheet 100E of the third embodiment is not formed on the side of an exposed surface 102FS of the second layer portion 1022F. Instead, in the pen input device sheet 100F of the fourth embodiment, a second uneven pattern PTF2 is made by forming projecting portions PF2a and projecting portions PF2b on upper surfaces of projecting portions PF1 and bottom surfaces of recessed portions CF1, respectively, in a first uneven pattern PTF1 included in a first layer portion 1021F. That is, in the pen input device sheet 100F of the fourth embodiment, the second uneven pattern PTF2 is formed to overlap the first uneven pattern PTF1.

In the fourth embodiment, for the first layer portion 1021F, a lattice-shaped pattern composed of a UV-curable material is formed on a base 101F as with the pen input device sheet 100E of the third embodiment, to form the first uneven pattern PTF1. Further, in the fourth embodiment, the projecting portions PF2a of the second uneven pattern PTF2 are formed on the lines composed of the UV-curable material forming the first uneven pattern PTF1, that is, on the upper surfaces of the projecting portions PF1. In addition, the projecting portions PF2b of the second uneven pattern PTF2 are formed in space portions in which the UV-curable material does not exist, that is, on the bottom surfaces of the recessed portions CF1. Moreover, as depicted in FIG. 20, the recessed portions CF1 of the first uneven pattern PTF1 are filled with a polyurethane resin monolithic with the second layer portion 1022F as in the third embodiment.

As described also for the pen input device sheet 100 of the first embodiment, in a case in which the second uneven pattern PTF2 is considered as being divided into an uneven pattern composed of the projecting portions PF2a formed on the projecting portions PF1 of the first uneven pattern PTF1 and recessed portions around them and another uneven pattern composed of the projecting portions PF2b formed on the recessed portions CF1 of the first uneven pattern PTF1 and recessed portions around them, the uneven pattern composed of the projecting portions PF2a formed on the projecting portions PF1 of the first uneven pattern PTF1 and the recessed portions around them can be regarded as a layer portion different from the first layer portion 1021F. In this case, the elastic material layer 102F can be considered as a component having three layer portions.

The second uneven pattern PTF2 of the pen input device sheet 100F of the fourth embodiment also acts to disperse the sharp peak waveform of the vibration frequency characteristic of the kinetic friction coefficient of the pen input device sheet 100F, generated by the recesses and projections of the first uneven pattern PTF1, and form a peak waveform made broad in the vibration frequency distribution, as with the second uneven patterns PT2 to PTE2 of the pen input device sheets 100 to 100E of the above-described first to third embodiments. However, in the case of the fourth embodiment, the anti-glare effect by the second uneven pattern PTF2 is absent.

Also in the pen input device sheet 100F of the fourth embodiment, modifications similar to those of the pen input device sheet 100 of the above-described first embodiment, such as changing the part of the base 101F to an adhesive layer, are possible.

### Other Embodiments or Modifications

The pen input device sheets of the above-described embodiments correspond to the case in which the target combination of the writing material and the writing medium a writing feel with which is desired to be obtained with the electronic pen is a combination of a pencil and copy paper. However, the target combination of the writing material and the writing medium is not limited thereto, and various combinations such as a combination of a ballpoint pen and report paper are possible.

Moreover, in the above-described second to fourth embodiments, the hard components 1021Da to 1021Fa for forming the first uneven patterns PTD1 to PTF1 in the first layer portions 1021D to 1021F of the elastic material layers 102D to 102F are formed by executing UV printing with a UV-curable ink. However, the method for forming the hard component is not limited to UV printing, and any method may be employed as long as it is a method that can form the hard component. Further, the uneven shape may be formed by a method of deforming a surface of a base. In addition, the same applies to the transferred uneven portion 402 to be formed on the base film 401 of the transfer film component 400, and the method for forming the transferred uneven portion 402 is not limited to the method using UV printing with a UV-curable ink.

Moreover, the hard components 1021Da to 1021Fa for forming the first uneven patterns are formed as the lattice-shaped patterns in the above-described embodiments, but are not limited to the lattice-shaped patterns. For example, a UV-curable resin with a shape of short lines may be disposed on a base. Alternatively, a UV-curable resin with a shape of dots may be disposed in the first layer portion 1021D to 1021F of the elastic material layer or on a base.

In a case in which the pen input device sheet is assumed to be disposed on a pen tablet-type terminal with which the pen input device sheet is not disposed on a display screen, the adhesive layer, the base, and the elastic material layer can be formed by a non-optical material. In a case in which the pen input device sheet is assumed to be disposed on a display screen, the adhesive layer, the base, and the elastic material layer are formed by a material having optical characteristics.

Further, in the above-described embodiments, the electronic pen and the position detecting device are configured by ones of the electromagnetic induction system. However, the electronic pen and the position detecting device with which the pen input device sheet according to this invention is used are not limited to ones of the electromagnetic induction system, and may be ones of any system such as a capacitive coupling system or another system.

It is to be noted that the embodiment of this invention is not limited to the foregoing embodiments, and that various changes can be made without departing from the spirit of this invention.

What is claimed is:

1. A pen input device sheet to be disposed over a position detection region of a position detecting sensor, the pen input device sheet comprising:
an elastic material layer that has elasticity and has a side opposite to a side of the position detecting sensor employed as a side of a writing input surface to which writing input with an electronic pen is to be made, wherein
the elastic material layer has a first uneven pattern formed along a direction orthogonal to a thickness direction of the elastic material layer and a second uneven pattern that is formed along a direction orthogonal to the thickness direction of the elastic material layer and is different from the first uneven pattern.

2. The pen input device sheet according to claim 1, wherein
the first uneven pattern has recesses and projections repeated such that a mean interval of the recesses and the projections is a predetermined value.

3. The pen input device sheet according to claim 1, wherein
the second uneven pattern has recesses and projections repeated such that a mean interval of the recesses and the projections is a predetermined value, or has recesses and projections irregularly disposed.

4. The pen input device sheet according to claim 1, wherein
the second uneven pattern is formed to have a mean interval of recesses and projections shorter than a mean interval of recesses and projections of the first uneven pattern.

5. The pen input device sheet according to claim 1, wherein
the second uneven pattern is formed to have recesses and projections with a size smaller than a size of recesses and projections of the first uneven pattern.

6. The pen input device sheet according to claim 1, wherein
the elastic material layer has a plurality of layer portions in the thickness direction and includes a first layer portion on the side of the position detecting sensor and a second layer portion on the side of the writing input surface, and the second uneven pattern is formed on the side of the writing input surface in the second layer portion.

7. The pen input device sheet according to claim 1, wherein
the elastic material layer has a plurality of layer portions in the thickness direction and includes a first layer portion on the side of the position detecting sensor and a second layer portion on the side of the writing input surface,
the first uneven pattern is formed in the second layer portion, and
the second uneven pattern is formed on bottom surfaces of recessed portions and/or upper surfaces of projecting portions in the first uneven pattern.

8. The pen input device sheet according to claim 1, wherein
a material having elasticity in the elastic material layer is a polyurethane resin.

9. The pen input device sheet according to claim 1, wherein
a material having elasticity in the elastic material layer is a polyvinyl chloride resin.

10. The pen input device sheet according to claim 1, wherein
a base layer is disposed on a surface on a side of the elastic material layer between the position detecting sensor and the elastic material layer.

11. The pen input device sheet according to claim 1, wherein
an adhesive layer is disposed on a surface on a side of the elastic material layer between the position detecting sensor and the elastic material layer.

12. The pen input device sheet according to claim 10, wherein
an adhesive layer is disposed on a surface on a side of the base layer between the position detecting sensor and the base layer.

13. The pen input device sheet according to claim 1, wherein
recessed portions of the first uneven pattern are not filled with a material but filled with air.

14. The pen input device sheet according to claim 1, wherein
the second uneven pattern is exposed on the side of the writing input surface.

15. The pen input device sheet according to claim 1, wherein
the elastic material layer has a plurality of layer portions in the thickness direction and includes a first layer portion on the side of the position detecting sensor and a second layer portion on the side of the writing input surface, and the first uneven pattern is formed in the first layer portion.

16. The pen input device sheet according to claim 15, wherein
projecting portions of the first uneven pattern are formed by a component composed of a material harder than recessed portions of the first uneven pattern.

17. The pen input device sheet according to claim 16, wherein
the projecting portions of the first uneven pattern are formed by a component composed of a material harder than a material of a layer portion in which the first uneven pattern is not formed.

18. The pen input device sheet according to claim 16, wherein
the component composed of the harder material is formed by an ultraviolet-curable resin.

19. The pen input device sheet according to claim 1, wherein
the first uneven pattern is a lattice-shaped pattern.

20. The pen input device sheet according to claim 18, wherein
the first uneven pattern is a lattice-shaped pattern, and
the component composed of the harder material is formed as a lattice-shaped pattern that fits the first uneven pattern.

21. The pen input device sheet according to claim 1, wherein
the first uneven pattern is a dot-shaped pattern.

22. The pen input device sheet according to claim 18, wherein
the first uneven pattern is a dot-shaped pattern, and
the component composed of the harder material is formed as a dot-shaped pattern that fits the first uneven pattern.

23. The pen input device sheet according to claim 5, wherein
the second uneven pattern is exposed on the side of the writing input surface, and
the second uneven pattern has an anti-glare property for preventing reflection of light by a writing surface.
